(19) United States
(12) Patent Application Publication
(10) Pub. No.: US 2017/0353998 A1
(43) Pub. Date: Dec. 7, 2017

(54) COOKING APPARATUS AND COOKING SYSTEM

(71) Applicant: Samsung Electronics Co., Ltd, Gyeonggi-do (KR)

(72) Inventors: Jae-hoon Cha, Suwon-si (KR); Su-ho Jo, Yongin-si (KR); Kwan-joo Myoung, Suwon-si (KR)

(21) Appl. No.: 15/612,990

(22) Filed: Jun. 2, 2017

Related U.S. Application Data
(60) Provisional application No. 62/345,725, filed on Jun. 3, 2016.

(30) Foreign Application Priority Data
Oct. 19, 2016 (KR) 10-2016-0135568

(51) Int. Cl. H05B 6/68; A47J 36/32; A47J 27/00

(52) U.S. Cl. CPC H05B 6/687; A47J 27/004; A47J 36/32

(57) ABSTRACT

A cooking apparatus is disclosed. The cooking apparatus may include a cooking compartment in which food is placed, a control substrate configured to receive an input of user manipulation, a communicator configured to receive cooking data from an external electronic device by a wireless communication method, and be mounted on a backside of the control substrate and a processor configured to perform cooking based on at least one of the user manipulation input through the control substrate and the received cooking data.

### CROSS-REFERENCE TO RELATED APPLICATION(S) AND CLAIM OF PRIORITY

The present application is related to and claims priority from Korean Patent Application No. 10-2016-0135568, filed in the Korean Intellectual Property Office on Oct. 19, 2016, and U.S. Provisional Application No. 62/345,725, filed in the U. S. Patent and Trademark Office on Jun. 3, 2016, the disclosures of which are incorporated herein by references in their entirety.

### TECHNICAL FIELD

Aspects of the example embodiments relate to a cooking apparatus and a cooking system, and more particularly, to a cooking apparatus configured to easily transmit to, and receive cooking data from, another electronic device and a cooking system thereof.

### BACKGROUND

A heating cooking apparatus that performs cooking by increasing the temperature of food has been commonly used as a cooking apparatus. A heating cooking apparatus generally includes a microwave oven that irradiates microwave to food, a gas oven that applies heat directly to food, an electronic oven, and the like. A microwave oven is a cooking apparatus that irradiates microwave generated from a magnetron to food, and performs cooking using fabrication heat produced by translation motion of water molecules included in food.

A cooking apparatus usually includes various buttons for selecting cooking functions, and a user cooks food by manipulating the buttons. Recently, the market has introduced a cooking apparatus that automatically performs cooking by a simple selection of a key that has been programmed depending on a cooking object or a cooking type so that a user can cook without any separate complex manipulation.

However, as such an automatic cooking function is programmed in a cooking device beforehand, cooking might not be performed in an order that a user intends. There has accordingly been a need for an automatic cooking function that can be directly programmed by a user. There also has been a need for a function of sharing an automatic cooking function programmed in one cooking apparatus with a plurality of cooking apparatuses in order to cook food with a same food quality in the plurality of cooking apparatuses.

### SUMMARY

An aspect of example embodiments relates to a cooking apparatus that can easily transmit cooking data to, and receive cooking data from, another electronic device and a cooking system thereof.

To address the above-discussed deficiencies, it is a primary object to provide a cooking apparatus, the cooking apparatus including a cooking compartment in which food is placed, a control substrate configured to receive an input of user manipulation, a communicator configured to receive cooking data from an external electronic device by a wireless communication method, and be mounted on the backside of the control substrate, and a processor configured to perform cooking based on at least one of the user manipulation input through the control substrate and the received cooking data.

The communicator may be fixed in a groove formed on the backside of the control substrate.

The wireless communication method may be at least one of NFC, Wi-Fi and Bluetooth.

The control substrate may include a plurality of button areas provided on the front side of the control substrate.

The communicator may be fixed in a groove formed on an area of the backside of the control substrate, the area that does not correspond to the plurality of button areas.

The cooking apparatus according to an example embodiment may further include a display configured to, in response to a control command for connecting to an external electronic device being input, display a random number, and the processor transmits information corresponding to the displayed random number to the external electronic device through the communicator.

A cooking apparatus according to an example embodiment may further include a storage configured to store a plurality of pieces of cooking data and information on a plurality of numbers mapped to each of the plurality of pieces of cooking data, wherein the processor, in response to a number being input through the control substrate, performs cooking using cooking data mapped to the input number among the plurality of pieces of cooking data.

The received cooking data may include information on a cooking type, a cooking temperature and a cooking time.

The communicator may receive cooking data and information on a number mapped to the cooking data from the external electronic device, and the processor may replace cooking data mapped to a number corresponding to the received information on the number among the plurality of pieces of cooking data stored in the storage, with the received cooking data.

The processor the processor may, in response to receiving a request for cooking data from the external electronic device, control the communicator to transmit the plurality of pieces of cooking data and information on a plurality of numbers mapped to each of the plurality of pieces of cooking data, to the external electronic device.

The processor may control a communication function not to be activated while cooking is performed, and control cooking not to be performed while a communication function is activated.

A cooking apparatus according to another example embodiment may include a cooking compartment in which food is placed, a communicator configured to transmit cooking data to, and receive cooking data from, an external electronic device by a Bluetooth communication method and a processor configured to control the communicator to receive cooking data from the external electronic device or to transmit pre-stored cooking data to the external electronic device, and perform cooking based on the pre-stored cooking data or the received cooking data.

According to an example embodiment, a method for controlling a cooking apparatus comprising a cooking compartment in which food is placed, the method may include receiving cooking data from an external electronic device by a Bluetooth communication method, performing cooking based on the received cooking data or pre-stored cooking data and transmitting the pre-stored cooking data to the external electronic device by a Bluetooth communication method.

A cooking system according to an example embodiment may include a cooking apparatus configured to generate cooking data according to a user input and an electronic device configured to receive the generated cooking data from the cooking apparatus, wherein the cooking apparatus transmits the generated cooking data to the electronic device by a Bluetooth communication method.

The cooking data may include information on a cooking type, a cooking temperature and a cooking time.

A cooking system according to another example embodiment may include an electronic device configured to store cooking data and a cooking apparatus configured to receive cooking data from the electronic device by a Bluetooth communication method, and perform cooking based on the received cooking data.

The cooking data may include information on a cooking type, a cooking temperature and a cooking time.

A cooking system according to an example embodiment may include a first cooking apparatus configured to generate cooking data according to a user input, an electronic device configured to receive the generated cooking data from the first cooking apparatus by a Bluetooth communication method and a second cooking apparatus configured to receive the generated cooking data from the electronic device by a Bluetooth communication method, and perform cooking based on the received cooking data.

The electronic device may include a communicator configured to communicate with the first cooking apparatus and the second cooking apparatus, a display configured to display a first UI element for receiving cooking data from the first cooking apparatus, a second UI element for transmitting cooking data to the second cooking apparatus and a third UI element for sharing cooking data with another electronic device and a processor configured to, in response to the first UI element being selected, control the communicator to receive cooking data from the first cooking apparatus.

The processor may, in response to the second UI element being selected, display at least one of pieces of pre-stored cooking data, and in response to a piece of cooking data being selected from among at least one piece of the displayed cooking data and a value included in the selected cooking data being invalid, control the display to display an error message.

The processor may control the display to display an UI element for editing the selected cooking data along with the error message.

The processor may, in response to a value included in the selected cooking data being valid, control the communicator to transmit the selected cooking data to the second cooking apparatus.

The communicator may receive information on a number displayed on a display panel of the first or the second cooking apparatus from the first or the second cooking apparatus, and the processor may control the display to display a fourth UI element including a number corresponding to the received information on the number, and in response to the fourth UI element being selected, control the communicator to connect to the first or the second cooking apparatus.

The processor may, in response to the third UI element being selected, control the display to display at least one piece of pre-stored cooking data, and control the communicator to transmit the cooking data selected from among at least one piece of the displayed cooking data to at least one of other pre-registered electronic devices.

The processor may, in response to completing reception of cooking data from the first cooking apparatus, control the display to display a UI element for sharing the received cooking data with another electronic device and an UI element for editing the received cooking data.

The electronic device may, in response to receiving a plurality of pieces of cooking data from the first cooking apparatus, generate a group of cooking data including the plurality of pieces of received cooking data in an excel file format.

A method for controlling an electronic device according to an example embodiment, the method may include receiving cooking data from a first cooking apparatus by a Bluetooth communication method, displaying a UI screen for receiving a selection of an object to which the received cooking data is transmitted and transmitting the received cooking data to another electronic device according to a user manipulation through the UI screen.

The method according to an example embodiment may include displaying a result of searching for another nearby electronic device by a Bluetooth communication method, wherein the receiving may include, in response to the first cooking apparatus being selected from the displayed search result, receiving cooking data from the first cooking apparatus.

The UI screen may include a result of searching for another nearby electronic device by a Bluetooth communication method, and the transmitting may include, in response to a second cooking apparatus being selected from the UI screen, transmitting cooking data to the second cooking apparatus by a Bluetooth communication method.

The transmitting may include transmitting cooking data by at least one of an email, an instant message and a multimedia messaging service (MMS) according to a user manipulation through the UI screen.

The method according to an example embodiment may further include, in response to a recipe application stored in the electronic device being executed, displaying a first UI element for receiving cooking data from a cooking apparatus, a second UI element for transmitting cooking data to a cooking apparatus and a third UI element for sharing cooking data with another electronic device, and in response to the first UI element being selected, displaying at least one of cooking apparatuses to be connected to the electronic device, and the receiving may include, in response to the first cooking apparatus being selected from among at least one of the displayed cooking apparatuses, receiving cooking data from the first cooking apparatus.

The method according to an example embodiment may further include, in response to the second UI element or the third UI element being selected, displaying information on at least one piece of pre-stored cooking data.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a cooking system according to an example embodiment;

FIG. 2 is a diagram illustrating a cooking system according to another example embodiment;

FIG. 3 is a diagram illustrating a cooking apparatus according to an example embodiment;

FIGS. 4, 5, 6, and 7 are diagrams illustrating a communicator of a cooking apparatus;

FIGS. 8A and 8B are diagrams illustrating connection between a processor and a communicator within a cooking apparatus;

FIG. 9 is a block diagram illustrating configurations of a cooking apparatus and of an electronic device according to an example embodiment;

FIGS. 10-11 are diagrams illustrating a number displayed for mutual connection on a cooking apparatus and an electronic device according to an example embodiment;

FIGS. 12A, 12B, 12C, 12D, 12E and 12F are diagrams illustrating a UI screen through which an electronic device receives cooking data according to an example embodiment;

FIGS. 13A, 13B, 13C, 13D, 13E and 13F are diagrams illustrating a UI screen through which an electronic device transmits cooking data according to an example embodiment;

FIGS. 14A, 14B, 14C, 14D, 14E, and 14F are diagrams illustrating a UI screen through which an electronic device edits cooking data according to an example embodiment;

FIGS. 15, 16 and 17 are diagrams illustrating an excel file format of cooking data according to an example embodiment;

FIGS. 18, 19, 20, 21 and 22 are diagrams illustrating a method for controlling an electronic device according to various example embodiments.

### DETAILED DESCRIPTION

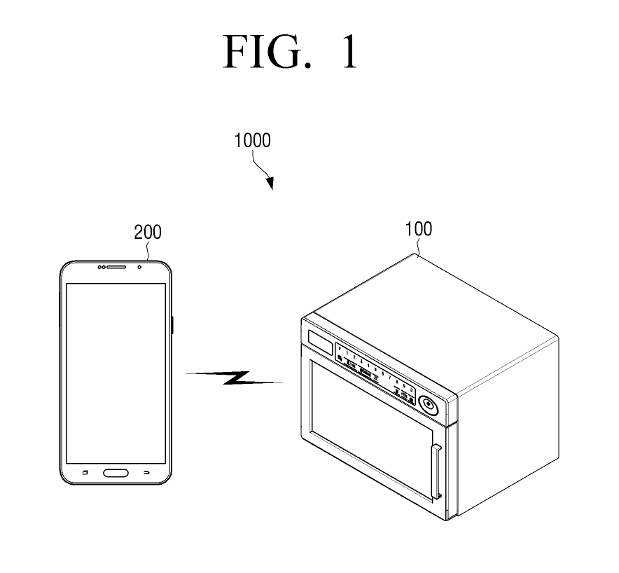

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, example embodiments will be described in more detail with reference to the accompanying drawings.

The terms used in an example embodiment are defined in consideration of a function described in an example embodiment, and the terms may vary according to an intention of a technician practicing in the pertinent art, an advent of new technology, etc. In specific cases, terms may be chosen arbitrarily, and in this case, definitions thereof will be described in the description of the corresponding disclosure. Therefore, the terms used in the description should not necessarily be construed as simple names of the terms, but be defined based on meanings of the terms and overall contents of the present disclosure.

The example embodiments may vary, and may be provided in different example embodiments. Various example embodiments will be described with reference to accompanying drawings. However, this does not necessarily limit the scope of the example embodiments to a specific embodiment form. Instead, modifications, equivalents and replacements included in the disclosed concept and technical scope of this description may be employed. Also, well-known functions or constructions are not described in detail since they would obscure the disclosure with unnecessary detail.

The terms such as “first” and “second” may be used to explain various elements, but the elements should not be limited by these terms. The terms are used solely for the purpose of distinguishing one element from another element.

A singular term includes a plural form unless otherwise indicated. It should be understood that the terms “include” or “have” used in the example embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

In an example embodiment, ‘a module’ or ‘a unit’ performs at least one function or operation, and may be realized as hardware, software, or combination thereof. Further, except the “modules” or “units” that have to be implemented as certain hardware, a plurality of “modules” or a plurality of “units” may be integrated into at least one module and realized as at least one processor.

Hereinafter, the example embodiments of the present disclosure will be described in greater detail with reference to the accompanying drawings, so that a person skilled in the art can easily implement the example embodiments. However, the example embodiments may be implemented as various different forms, and is not limited to the example embodiments described herein. In the drawings, parts that are not relevant to the description may be omitted to clearly describe the embodiments, and like drawing reference numerals are used for the like elements throughout the specification.

Hereinafter, the present disclosure will be described in more detail with reference to the accompanying drawings.

FIG. 1 is a diagram illustrating a cooking system according to an example embodiment.

The cooking system 1000 may include a cooking apparatus 100 and an electronic device 200.

The cooking apparatus 100 is an apparatus that can heat food placed in a cooking compartment, and may be referred to as an oven. In particular, the cooking apparatus 100 may be implemented as an apparatus that can communicate with an external electronic device.

The cooking apparatus 100 may be, for example, a conventional oven that heats a whole inside of an oven by at least one heat source, a convection oven that circulates heat produced by an internal heat source using a fan, a light wave oven that heats food using a halogen heater, a microwave oven that heats food using microwave and a hybrid oven (e.g., a conventional oven+a microwave oven) that supports a plurality of different heating methods, but not limited thereto.

The electronic device 200 may be a device that can communicate with the cooking apparatus 100, and may be implemented as a variety of electronic devices such as a smartphone, a tablet PC, a laptop, a desktop, a remote controller, a wearable device, or the like.

The cooking apparatus 100 and the electronic device 200 may be connected through wireless communication, and transmit cooking data to, and receive cooking data from, each other. In FIG. 1, only one cooking apparatus and one electronic device are illustrated, but one cooking apparatus may be connected to a plurality of electronic devices, and a plurality of cooking apparatuses may be connected to one electronic device.

The cooking data may be data of an operation order to cook food in the cooking apparatus 100, and may be referred to as a recipe or data for automatic cooking. For instance, cooking data comprises a data set that includes ‘in what watt strength and for how many seconds the oven should be operated to cook a certain food’ as one stage.

As an example, in the event of cooking pizza, if the stages of ‘for 30 seconds in 1000 W’ (a first stage), ‘for 60 seconds in 500 W’ (a second stage), ‘for 120 seconds in 900W’ (a third stage) should be proceeded in order, the cooking data may be all the relevant values and sequence data.

The cooking apparatus 100 may perform cooking on the basis of the cooking data even if a user does not input cooking values directly.

The cooking data may be generated in the cooking apparatus 100, or may be generated in an electronic device and provided to the cooking apparatus 100.

In the aforementioned cooking system, it may be easy to transmit and receive cooking data between the cooking apparatus 100 and the electronic device 200. Therefore, it may be particularly useful when a plurality of cooking apparatuses need to share same cooking data in order to cook food with a same food quality in the plurality of cooking apparatuses.

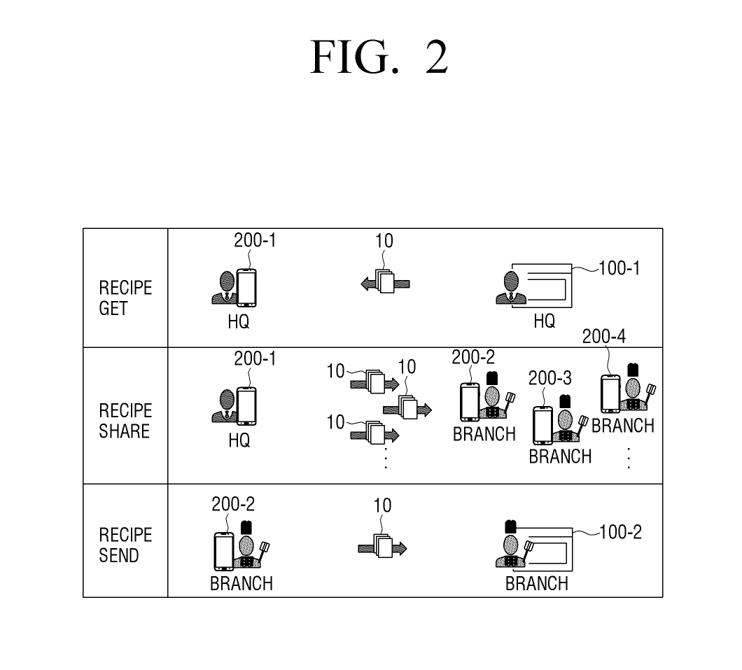

FIG. 2 is a diagram illustrating a system for sharing cooking data generated in one cooking apparatus with a plurality of cooking apparatuses.

Referring to FIG. 2, cooking data 10 may be generated in a cooking apparatus 100-1 of a headquarter, and the cooking data 10 may be transmitted to an electronic device 200-1 of the headquarter. Then, the cooking data 10 stored in the electronic device 200-1 may be transmitted to electronic devices 200-2, 200-3 and 200-4 of a plurality of branches by sending an email. The electronic device 200-2 of the branch may transmit the received cooking data 10 to the cooking apparatus 100-2 of the branch by a near field wireless communication method (e.g., Bluetooth). The electronic devices 200-3 and 200-4 of the rest of branches may transmit the cooking data 10 to cooking apparatuses of the respective branches by the same method.

As described above, cooking apparatuses of a plurality of branches can share cooking data created by a headquarter, thereby providing foods with a same food quality. Meanwhile, in FIG. 2, it is described that cooking data may be transmitted via the electronic devices 200-2, 200-3 and 200-4 of branches, but the electronic device 200-1 of a headquarter may also transmit cooking data directly to the cooking apparatus 100-2 of a branch by a near field wireless communication method (e.g., Bluetooth).

Hereinafter, the cooking apparatus and the electronic device will be described in more detail.

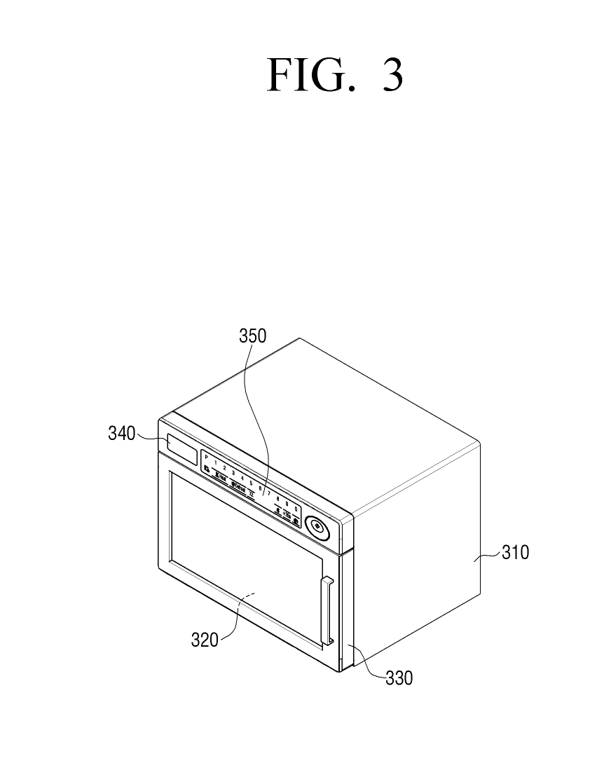

FIG. 3 is a diagram illustrating the cooking apparatus 100 according to an example embodiment.

The cooking apparatus 100 may include a housing 310, a cooking compartment 320 that is provided inside the housing 310 and in which food is placed, a door 330 that is provided on the front side of the housing 310 and opens and closes the cooking compartment 320.

The cooking apparatus 100 may further include a display 340 and an input unit 350.

The display 340 may display an operation state of the cooking apparatus 100. The display 340 may include a liquid crystal display (LDC) and a light emitting diode (LED).

As an example, the display 340 may include at least one flexible numeric display (FND). A FND is often used in expressing a number or a simple sign, and is referred to as a seven segment. There are two types of the seven segment: a common cathode and a common anode.

The input unit 350 may receive an input of a control command for controlling the cooking apparatus 100. The input unit 350 may include a control panel that includes a plurality of buttons and a control substrate in which a circuit that transmits, to a processor, a control signal corresponding to a button on the control panel is provided. The control substrate may include a plurality of button areas corresponding to each of the positions of a plurality of buttons provided on the control panel.

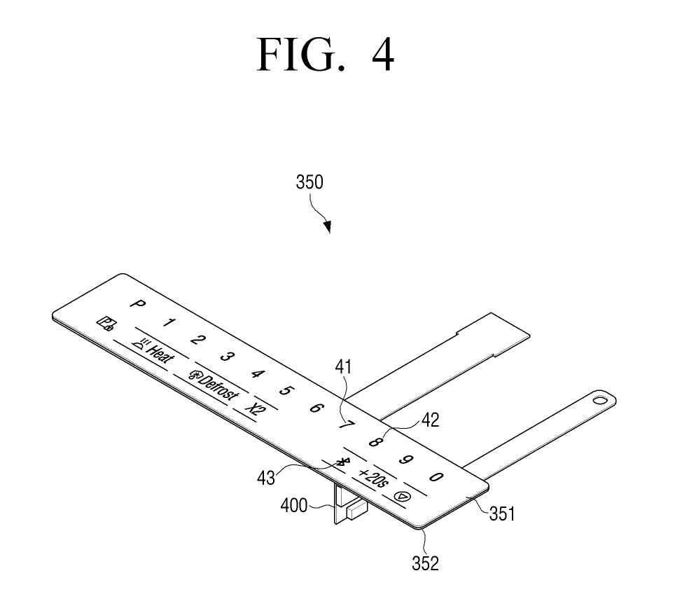

Although it is not illustrated in FIG. 3, a communicator configured to communicate with an external electronic device and a processor configured to control overall operations of the cooking apparatus 100 may be provided within the cooking apparatus 100. In particular, the communicator may be mounted on the backside of the control substrate of the input unit 350. An arrangement of the communicator will be described in more detail with reference to FIGS. 4-7.

FIG. 4 is a diagram illustrating an arrangement of the communicator in the cooking apparatus 100 according to an example embodiment.

Referring to FIG. 4, the input unit 350 may include the control panel 351 and the control substrate 352 that is provided on the backside of the control panel 351. The communicator 400 may be mounted on the backside of the control substrate 352.

The communicator 400 may communicate with an external electronic device wirelessly. For example, the communicator 400 may include a variety of communication chips such as a Wi-Fi chip, a Bluetooth chip, an NFC chip, a wireless communication chip, or the like. A Wi-Fi chip, a Bluetooth chip and an NFC chip may communicate by methods of Wi-Fi, Wi-Fi-direct, Bluetooth and NFC. The NFC chip refers to a communication chip that operates by an NFC method that uses a 13.56 MHz band among various RF-ID frequency bands such as 135 kHz, 13.56 MHz, 433 MHz, 860-960 MHz and 2.45 GHz. In case of using a Wi-Fi chip or a Bluetooth chip, various connection information such as a SSID, a session key, etc. may be firstly transmitted and received, communication connection is carried out, and then various information may be transmitted and received. The wireless communication chip refers to a communication chip that communicates according to various communication standards such as IEEE, ZigBee, 3rd Generation (3G), 3rd Generation Partnership (3GP), Long Term Evolution (LTE), and the like.

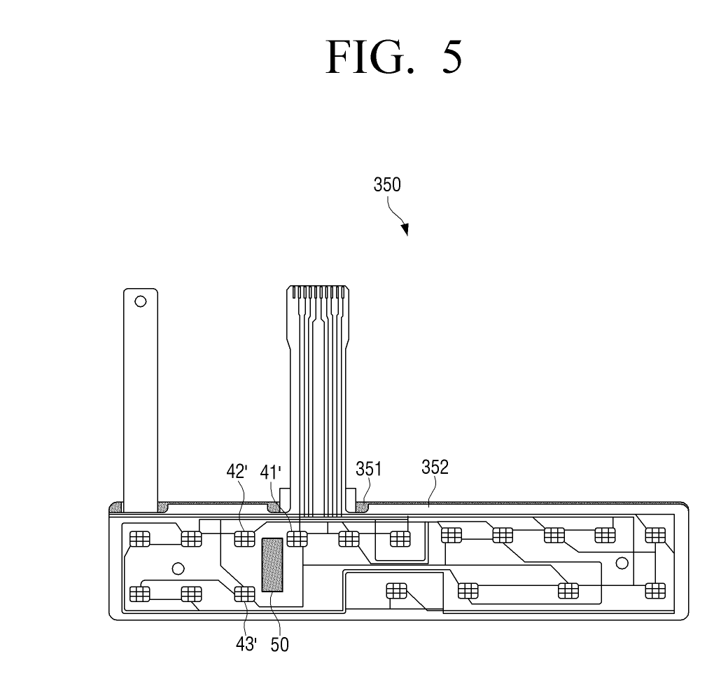

FIG. 5 shows the backside of the control substrate 352 according to an example embodiment. To be specific, FIG. 5 is an illustration of the backside of the control substrate 352 on which the communicator 400 is not mounted.

Referring to FIG. 5, a groove 50 may be formed on the backside of the control substrate 352. The groove 50 may be a part whose thickness is thinner than the thickness of the other area in the input unit 350. An area of the control substrate 352 may be scraped or bored to a certain depth in order to form the groove 50.

The groove 50 may be formed by scraping or boring an area of the input unit 350. Hence, the part where the groove 50 is formed should not cause any problem to an operation of the input unit 350, and also should not cause any problem when a user presses a button on the control panel 351.

The groove 50 should therefore be formed in an area other than the area where buttons are provided. To be more specific, there are a plurality of button areas corresponding to positions of a plurality of buttons provided on the control panel 351 on the front side of the control substrate 352 in order to generate a control signal corresponding to a motion of pressing a button provided on the control panel 351. The groove 50 may then be formed on the backside of the control substrate 352, the backside that does not correspond to the plurality of button areas provided on the front side of the control substrate 352.

Referring to FIGS. 4 and 5, for example, the groove 50 may be formed on the inner area avoiding a first area 41′, a second area 42′, and a third area 43′ that correspond to the positions of a first button 41, a second button 42 and a third button 43.

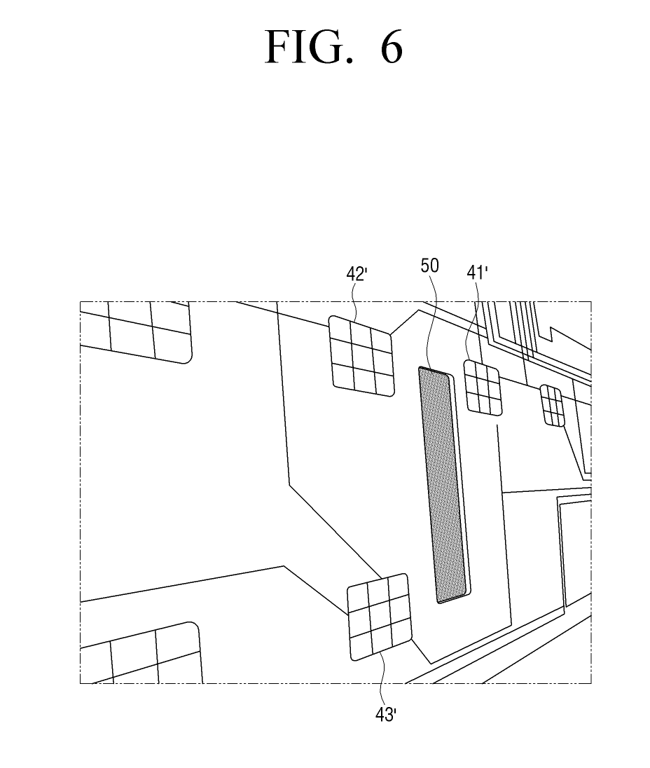

FIG. 6 illustrates an enlarged profile view of the groove 50 of FIG. 5. As shown in FIG. 6, the groove 50 is formed as an indentation so that the thickness of the groove 50 is thinner than that of the other area.

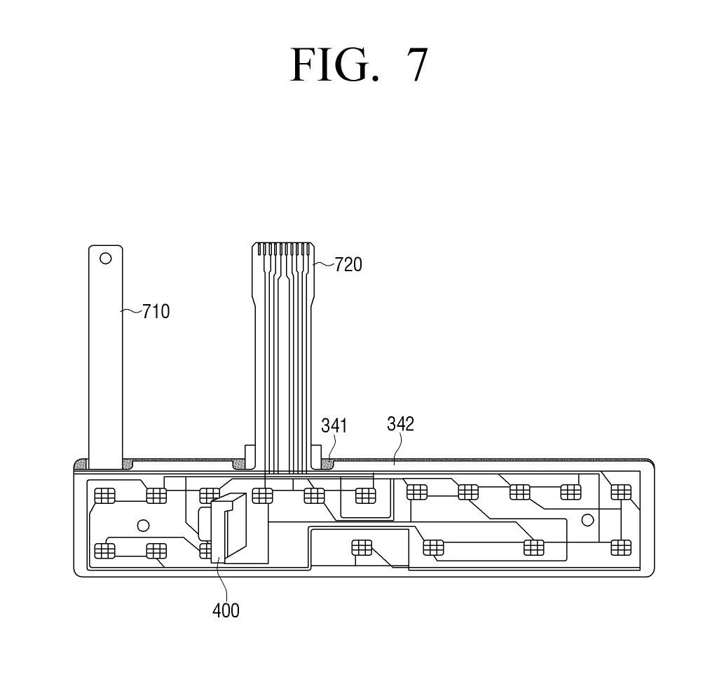

FIG. 7 is a diagram illustrating the state where the communicator 400 is fixed in the groove 50. The communicator 400 may be fixed on the groove 50 using an adhesive such as tape.

If the groove 50 is formed by scraping the backside of the control substrate 352 to a certain depth, the communicator 400 may be attached such that the communicator 400 touches the backside of the control substrate 352, and if the groove 50 is formed by boring the control substrate 352, the communicator 400 may be attached such that the communicator 400 touches the backside of the control panel 351.

According to an example embodiment, the communicator 400 may be fixed on the groove 50 physically, and be connected to the control substrate 352 electronically. The communicator 400 may also be connected to a processor through a conducting wire 720 that connects the input unit 350 and the processor.

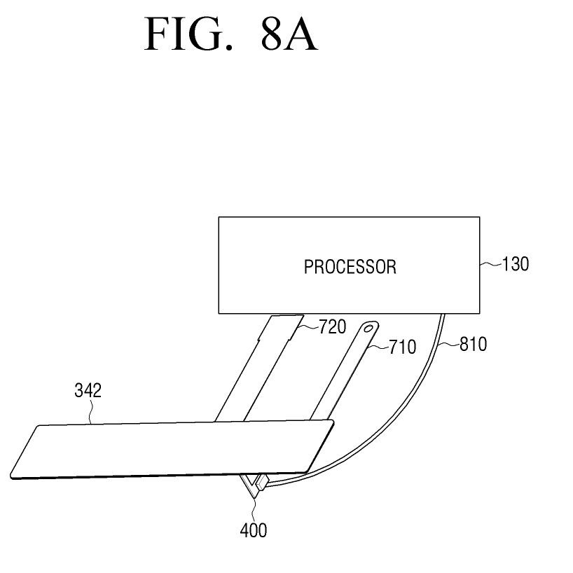

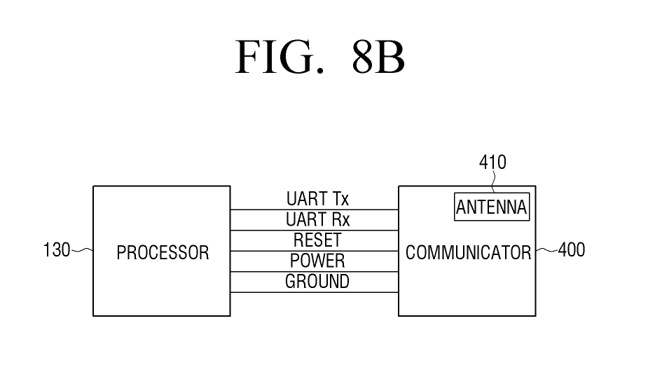

According to another example embodiment, the communicator 400 may be connected to the processor through a separate conducting wire (or a cable). The connection is illustrated in FIG. 8A.

Referring to 8A, the communicator 400 mounted on the backside of the control substrate 352 may not be electronically connected to the control substrate 352, but may be connected to the processor 130 through separate conduction wire 810, and the control substrate 352 may be connected to the processor 130 through the conducting wire 720. The sign 710 on the diagram indicates grounding. The processor 130 in the cooking apparatus 100 of FIG. 3 may be disposed in the upper space of the cooking compartment 320, and the conducting wire 720 of the control substrate 352 and the conducting wire 810 of the communicator 400 may be bent inwards and connected to the processor 130 disposed in the upper space of the cooking compartment 320.

A signal strength is important to communicate externally through the communicator 400 provided inside the cooking apparatus 100, but as most of the housings 310 of the cooking apparatus 100 is made of metal, the housing 310 can interfere with a communication signal. The control panel 351 and the control substrate 352, however, may be made of a non-metal material, and by disposing the communicator 400 on the backside of the control substrate 352 as described above, a wireless communication signal pass between an external electronic device and the communicator 400 may be secured accordingly. Further, by creating the groove 50 on the backside of the control substrate 352 so as to make the thickness of the groove part become thinner and disposing the communicator 400 in the groove, it may be possible to prevent reduction of a strength of a communication signal. Hence, according to the example embodiment, the cooking apparatus 100 and an external electronic device may communicate smoothly.

FIG. 8B is a diagram illustrating hardware connection between the processor 130 and the communicator 400 included in the cooking apparatus 100.

The processor 130 may include a CPU. Further, the processor 130 may be implemented as a micro-computer (MICOM), an application specific integrated circuit (ASIC) or the like.

Referring to 8B, the processor 130 and the communicator 400 may be connected by four wires. ‘UART Tx’ and ‘UART Rx’ are wires through which the processor 130 and the communicator 400 may send and receive data. ‘Reset’ may be a wire associated with resetting, and resetting may be carried out if there is no response after the processor 130 transmits a command to the communicator 400. ‘Power’ and ‘Ground’ are wires to supply power to the communicator 400.

An antenna 410 included in the communicator 400 may be a pattern antenna through which the communicator 400 carries out wireless communication.

The processor 130 may read cooking data stored in a storage, and transmit the cooking data to the communicator 400 through the aforementioned interface. The communicator 400 may transmit the received cooking data to an external electronic device, and may receive cooking data from an external electronic device.

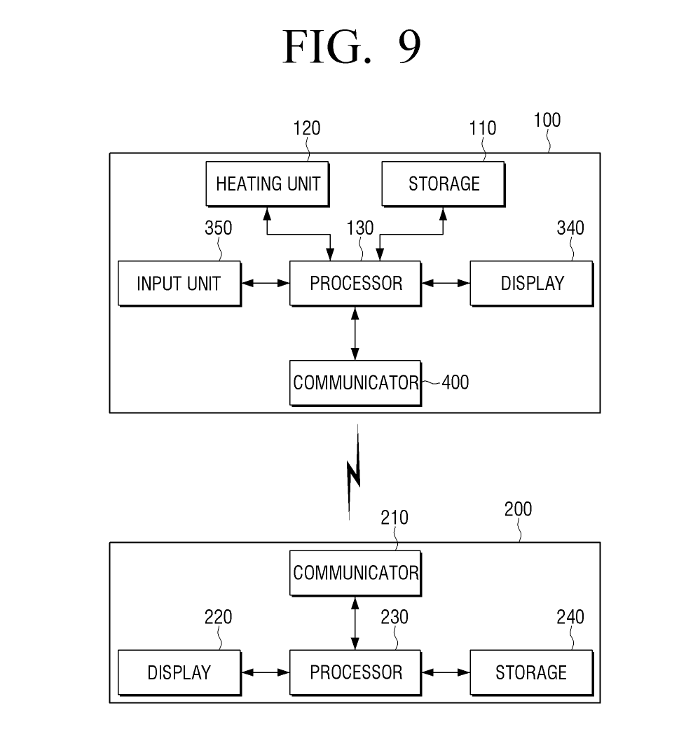

Hereinafter, a method for controlling transmission and reception of cooking data between the cooking apparatus 100 and an external electronic device will be described in detail by referring to FIG. 9.

Referring to FIG. 9, the cooking apparatus 100 may include a storage 110, a heating unit 120, the input unit 350, the communicator 400, the display 340 and the processor 130. Meanwhile, in describing the configuration of the cooking apparatus 100 with reference to FIG. 9, the description for the elements that have already been described above will be omitted.

The storage 110 may store various programs and data required to operate the cooking apparatus 100.

The storage 110 may be implemented as a non-volatile memory, a volatile memory, a flash memory, a hard disk drive (HDD), a solid state drive (SSD), or the like. The storage 110 may be accessed by the processor 130, and reading/recording/editing/deleting/updating of data may be carried out by the processor 130. The storage 110 may be implemented as a storage medium inside the cooking apparatus 100 or an external storage medium such as a USB, a web server through network or the like.

The storage 110 may store cooking data generated by a user manipulation through the input unit 350 or cooking data received from the electronic device 200. The cooking data may include information on a cooking type, a cooking temperature and a cooking time, and may also include information on a cooking order.

The storage 110 may store a plurality of pieces of cooking data and information on a plurality of numbers mapped to each of the plurality of pieces of cooking data.

The processor 130 may, in response to a request for cooking data being received from the electronic device 200, the processor 130 may control the communicator 400 to transmit a plurality of pieces of cooking data stored in the storage 110 and information on a plurality of numbers mapped to each of the plurality of pieces of cooking data, to the electronic device 200.

The processor 130 may, in response to a number being input through the control substrate 352 included in the input unit 350, perform cooking using cooking data mapped to the number being input among the plurality of pieces of stored cooking data. For example, referring to FIG. 4, in response to the button 7 (41), the processor 130 may perform cooking using cooking data mapped to number 7.

The processor 130 may, in response to cooking data and information on a number mapped to the cooking data being received from the electronic device 200 through the communicator 400, the processor 130 may replace (or update) cooking data mapped to a number corresponding to information on the received number among a plurality of pieces of cooking data stored in the storage 110, with the received cooking data.

The processor 130 may automatically perform cooking using cooking data as described above, and also may manually perform cooking on the basis of a user manipulation that is input through the control substrate 352. In other words, the processor 130 may perform cooking based on at least one of a user manipulation and cooking data that has been input through the control substrate 352.

The heating unit 120 may be a component for generating heat or microwave with respect to cooking functions according to controlling by the processor 130. The heating unit 120 may include a magnetron that irradiates microwave to the inside of the cooking compartment 320. Also, the heating unit 120 may include a grill heating unit that heats food by irradiating radiant heat or a convection heating unit that heats a food object by producing hot air.

The input unit 350 may receive various operation commands such as selecting cooking data, starting cooking, a cooking time, cancelling cooking or pausing, etc. The input unit may be provided with a button-type switch, a membrane switch, a dial, etc.

The communicator 400 may receive cooking data from the electronic device 200 by a wireless communication method, and transmit cooking data to the electronic device 200. The wireless communication method may be at least one of NFC, Wi-Fi, Wi-Fi direct and Bluetooth. The Bluetooth communication method may include Bluetooth Low Energy (BLE).

For example, the communicator 400 may transmit or receive cooking data by a Bluetooth communication method. To be specific, in response to a request for connection from the electronic device 200, a name and a unique address of the cooking apparatus 100 and other information may be transmitted to the electronic device 200. Then, the communicator 400 may receive the name and the unique address and other information. In this manner, the cooking apparatus 100 and the electronic device 200 may be connected to transmit connection information to, and receive connection information from, each other. Once connected, the cooking apparatus 100 may transmit cooking data to the electronic device 200 according to a request from the electronic device 200, and may also receive cooking data from the electronic device 200.

As another example, the communicator 400 may firstly transmit and receive various connection information such as an SSID and a session key to and from the communicator 210 of the electronic device 200 by an NFC communication method. Then, the communicator 400 and the communicator 210 may be connected using the received communication information, and transmit and receive cooking data by Bluetooth or Wi-Fi.

The display 340 may display various forms such as text, a number, an image, an icon, etc. The display 340 may display a time, a cooking mode, whether to activate a communication function, etc.

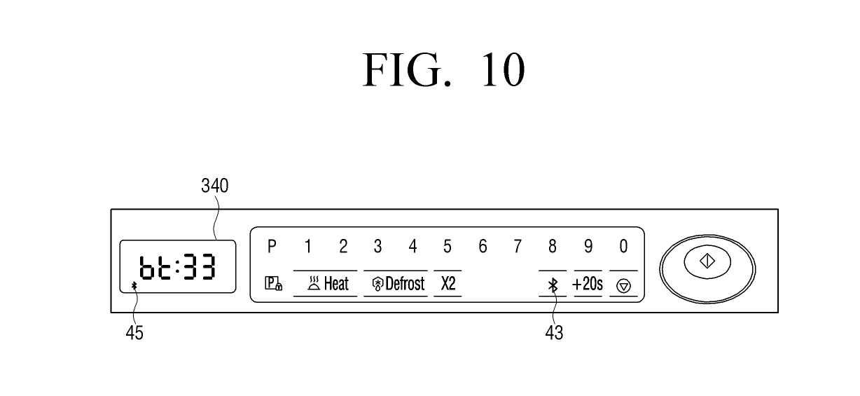

The display 340 may, in response to a control command for connecting to an external electronic device, display a random number. Then, the processor 130 may transmit information corresponding to the random number displayed on the display 340 to the electronic device 200 through the communicator 400. The control command for connecting to an external electronic device may correspond to a user manipulation of selecting a communication button provided in the input unit 350. The operation process will be explained by referring to FIG. 10.

FIG. 10 is a diagram illustrating an example in which the cooking apparatus 100 supports a Bluetooth communication method. The processor 130 may, in response to the Bluetooth button 43, which is a communication button, being selected, display a random number “33” on the display 340. Also, an icon 45 that indicates that Bluetooth has been activated and ‘bt,’ which is an abbreviation for Bluetooth, may be further displayed along with the number. As shown in FIG. 10, if the display 340 includes two FNDs for displaying a number, a random number between 00 and 99 may be displayed.

The processor may transmit information corresponding to the displayed number ‘33’ to the electronic device 200 through the communicator 400, and accordingly, when the electronic device 200 displays the cooking apparatus 100 on a list of apparatuses that have been retrieved by

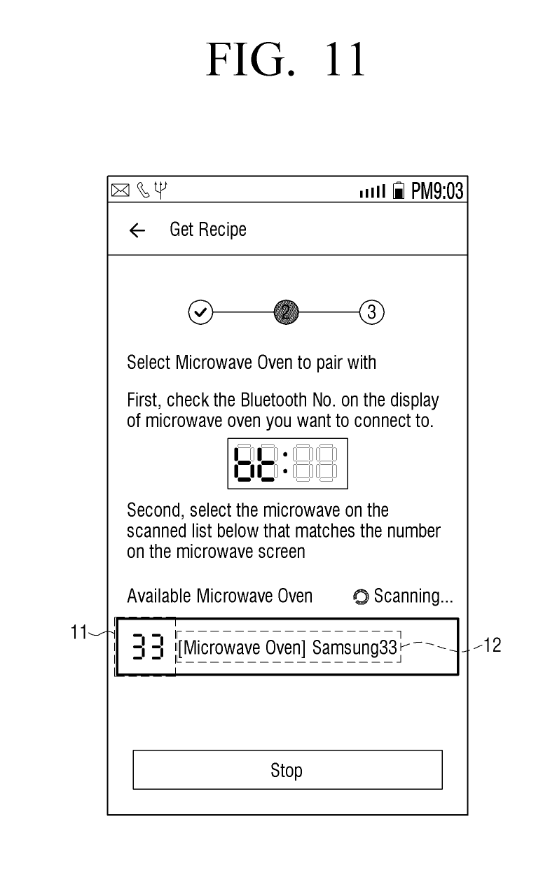

Bluetooth search, the electronic device 200 may display ‘33’ together. FIG. 11 shows a screen displayed on the electronic device 200 in accordance with the above example. Referring to FIG. 11, on the electronic device 200, a number 11 displayed on the cooking apparatus 100 may be displayed along with a name 12 of the cooking apparatus 100. The name 12 may also include a number displayed on the cooking apparatus 100. A user may easily identify the retrieved cooking apparatus by comparing the number displayed on the electronic device 200 and the number displayed on the cooking apparatus 100. The example embodiment may be useful in an environment where there are a plurality of cooking apparatuses.

When transmitting the information on the number, the communicator 400 may also transmit a name and a unique address of the cooking apparatus 100 and other information to the electronic device 200.

Meanwhile, microwave generated during cooking may interfere with a communication signal. The processor 130 may therefore control the cooking apparatus 100 not to activate a communication function while cooking is performed, and not to perform cooking while a communication function is activated.

For example, the processor 130 may not activate the communication function while cooking is performed even if a communication button of the input unit 350 is selected. Referring back to FIG. 10, when cooking is not performed, a mark such as an icon 45 indicating that Bluetooth is activated may be displayed on the display 340 if the Bluetooth button 43 is selected. However, while cooking is performed, icon 45 may not be displayed even if the Bluetooth button 43 is selected. Instead, a message such as “you cannot use a communication function during cooking” may be displayed on the display 340.

In addition, while the communication function is activated, a cooking function may not be performed even if a manipulation command for cooking is input through the input unit 350. In other words, even if a start cooking button is selected through the input unit 350, any operations associated with cooking may not be carried out. In this case, the message such as “you cannot use a communication function during cooking” may be displayed on the display 340.

Meanwhile, in the aforementioned example embodiment, the display 340 and the input unit 350 have been illustrated as discrete components, but the display 340 and the input unit 350 may be implemented as a touch screen that can display a screen and receive a touch manipulation of a user.

Referring back to FIG. 9, the electronic device 200 may include a communicator 210, a display 220, a processor 230 and a storage 240.

The communicator 210 may wirelessly communicate with the communicator 400. For example, the communicator 210 may include various communication chips such as a Wi-Fi chip, a Bluetooth chip, an NFC chip, a wireless communication chip or the like. The Wi-Fi chip, the Bluetooth chip and the NFC chip may carry out communication by methods of Wi-Fi, Wi-Fi-direct, Bluetooth and NFC. The Bluetooth method may include Bluetooth Low Energy (BLE). The wireless communication chip may refer to a chip that communicates according to various communication standards such as IEEE, ZigBee, 3rd Generation (3G), 3rd Generation Partnership (3GP), Long Term Evolution (LTE), or the like.

The display 220 may display various screens. The display 220 may, for example, be implemented as a Liquid Crystal Display (LCD), and may also be implemented as a cathode-ray tube (CRT), a plasma display panel (PDP), an organic light emitting diodes (OLED) and a transparent OLED (TOLED).

Further, the display 220 may be implemented as a form of a touch screen that can sense a touch manipulation of a user. A user may select various UI elements displayed on the touch screen. Or, the electronic device 200 may include separate input devices such as a keyboard, a mouse, a physical button, etc., and receive a selection of various UI elements displayed on the display 220 through the input devices.

The storage 240 may be implemented as a non-volatile memory, a volatile memory, a flash memory, a hard disk drive (HDD), a solid state drive (SSD), or the like. The storage 240 may also be implemented not only as a storage medium inside the electronic device 200 but also as an external storage medium such as a web server through a USB or network, or the like.

The storage 240 may include, for example, a kernel, a middleware, an application programming interface (API) or programming modules such as an application. The each of the programming modules may be configured as software, firmware and hardware or the combination of at least more than two of software, firmware and hardware. In the storage 240, an application for transmitting, receiving and sharing cooking data may be stored, and at least one cooking data may be stored. In some cases, a group of cooking data in which a plurality of pieces of cooking data are grouped may be stored in the storage 240.

The processor 230 may control overall operations of the electronic device 200. The processor 230 may include a CPU, an MPU, a GPU, a DSP, etc., and may also include an RAM, an ROM and a system buss. The processor 230 may be implemented as an MICOM, an ASIC or the like.

The processor 230 may, in response to an input of a command for scanning nearby devices, control the communicator 210 to search nearby devices by a wireless communication method. For example, the processor 230 may send a request for connecting to nearby devices by a Bluetooth communication method, receive names and addresses of nearby devices, and connect to the nearby devices by a Bluetooth communication method.

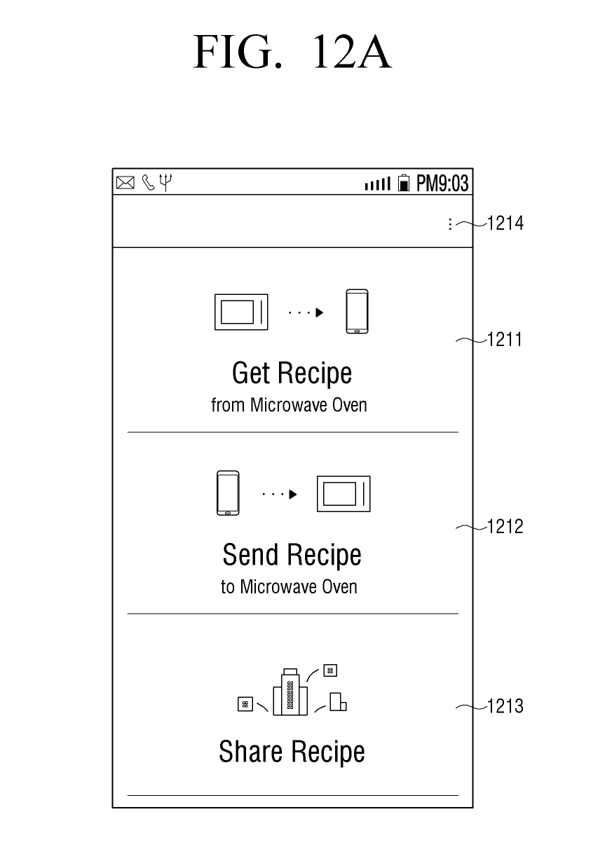

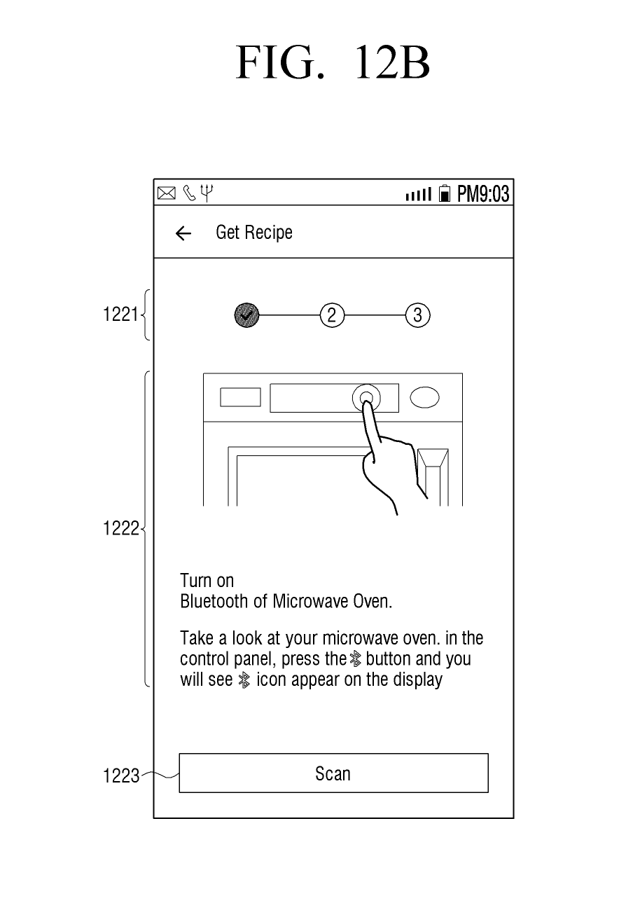

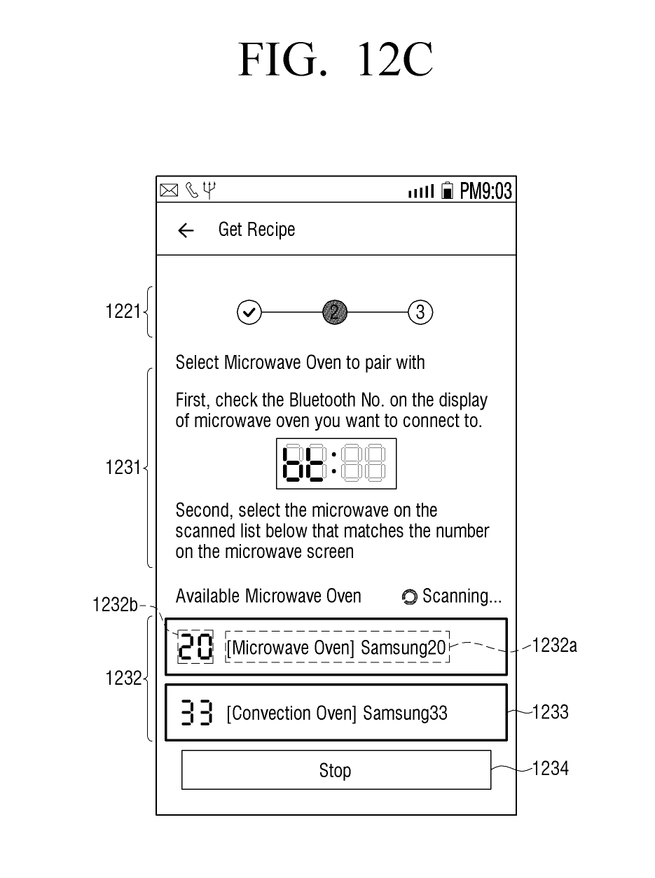

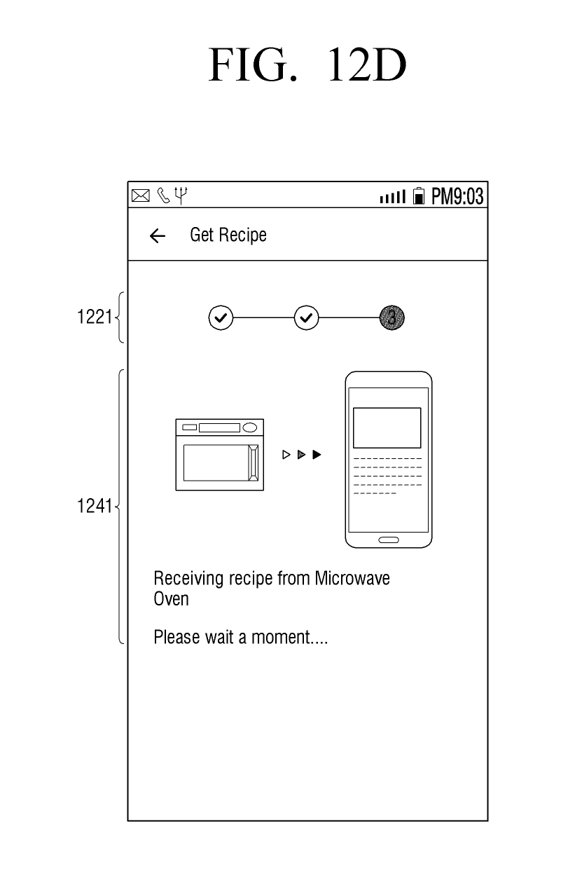

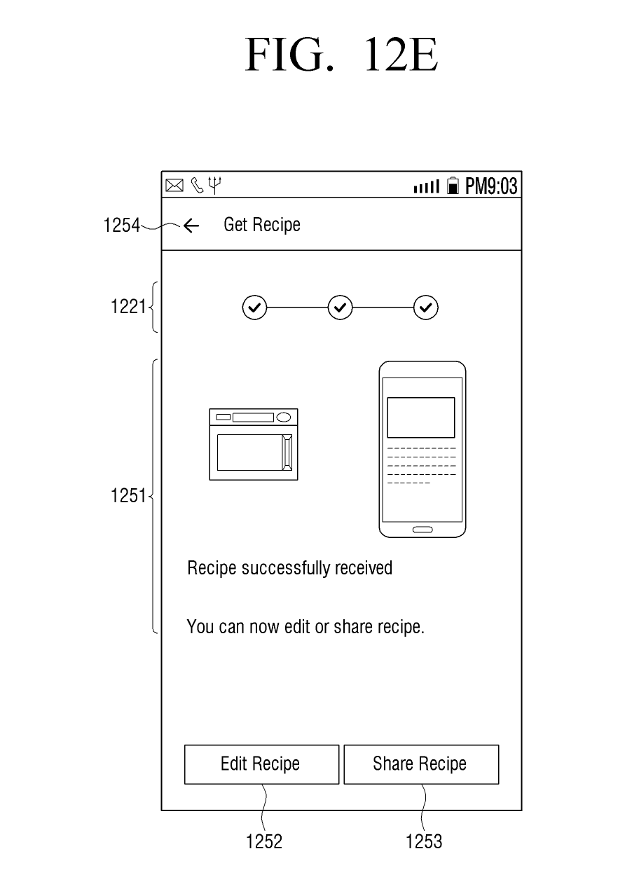

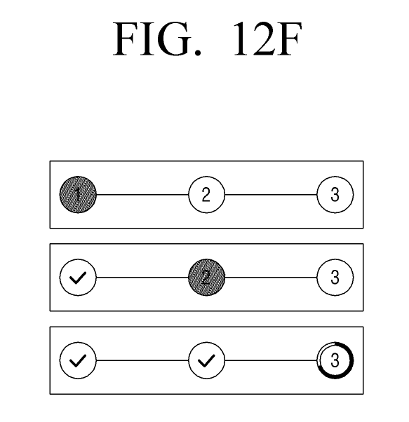

Hereinafter, referring to FIGS. 12A-12E, an example embodiment in which the electronic device 200 exports cooking data from the cooking apparatus 100 may be explained.

The processor 230 may execute an application (hereinafter, ‘a recipe App’) for transmitting, receiving and sharing cooking data according to a user command. FIG. 12A shows a home screen of the recipe App displayed on the display 220 when executing the recipe App.

Referring to FIG. 12A, the processor 230 may display a first UI element 1211 for receiving cooking data, a second UI element 1212 for transmitting cooking data to a cooking apparatus and a third UI element 1213 for sharing cooking data with another electronic device, through the display 220.

The processor 230 may, in response to the first UI element 1211 being selected while the cooking apparatus 100 is connected, control the communicator 210 to receive cooking data from the cooking apparatus 100. If the electronic device 200 is not currently connected to the cooking apparatus 100, the processor may, in response to the first UI element 1211 being selected, control the display 220 to display a screen of FIG. 12B.

FIG. 12B shows a screen that explains, to a user, a method for connecting to the cooking apparatus 100. The screen of FIG. 12B may include a stage notification UI element 1221 that notifies a user of a current stage among a series of stages until reception of cooking data is completed. The stage notification UI element 1221 may notify that the first stage has been completed. Also, the screen of FIG. 12B may notify that a communication function of the cooking apparatus should be activated to connect to the cooking apparatus, and may include a guide UI element 1222 that explains, to a user, how to activate the communication function of the cooking apparatus.

When a user selects a Bluetooth button 43 on the cooking apparatus 100, and then selects a scan UI element 1223 displayed on the screen of FIG. 12B, the processor 230 may control the display 220 to display the screen of FIG. 12C.

The screen of FIG. 12C may include the stage notification UI element 1221 as the screen of FIG. 12B does. The stage notification UI element 1221 may notify that a current stage is the second stage. The screen of 12C may include a UI element 1231 that notifies a number displayed on the cooking apparatus, and the UI element 1231 notifies that a device that has the same number as the number displayed on the cooking apparatus should be selected from the list of scanned devices displayed on the below of the screen.

As described above, the cooking apparatus 100 may, in response to a communication button provided in the input unit 350 being selected, display a random number on the display 340, and transmit information on the displayed number to the electronic device 200. Accordingly, when displaying a scan list 1232 including retrieved devices, the processor 230 may control the display 220 to display a name 1232A of the cooking apparatus 100 and a number 1232B displayed on the cooking apparatus 100 based on the received information on the number.

In other words, the communicator 210 may receive information on a number displayed on a display panel of the cooking apparatus from the cooking apparatus, and the processor 230 may control the display 220 to display a UI element 1233 including a number corresponding to the received information on the number.

On the screen of scanning result in FIG. 12C., if a stop UI element 1234 is selected, the apparatus scanning may be stopped.

In addition, in response to the UI element 1233 included in the scan list 1232 being selected, the processor 230 may control the communicator 210 to connect to the corresponding cooking apparatus.

Then, the processor 230 may control the communicator 210 to receive cooking data from the connected cooking apparatus, and control the display to display the screen that notifies that cooking data is currently being received as shown in FIG. 12D. The screen of FIG. 12D may include the stage notification UI element 1221 as the screens of FIGS. 12B and 12C do. The stage notification UI element 1221 may notify that the second stage has been completed, and a current stage is the third stage that is the last stage. Also, the screen of FIG. 12D may include a UI element 1241 that notifies that cooking data is currently being received from the cooking apparatus.

Meanwhile, the processor 230 may receive all cooking data stored in the cooking apparatus at once, or receive a part of the cooking data selectively. To achieve this, the processor 230 may further display a screen on which a user selects to receive all cooking data or to receive a part of the cooking data after the screen of FIG. 12C and before the screen of FIG. 12D. If a user selects to receive part of cooking data, the processor may receive and display a list of cooking data stored in the cooking apparatus, and have a user to select only data that the user wants, and only the selected cooking data may be received from the cooking apparatus. If a user selects to receive all cooking data, the processor may transmit a request for transmitting all the cooking data that the cooking apparatus has, and may control the communicator 210 to receive all the cooking data.

When reception of cooking data from the cooking apparatus is completed, the processor 230 may control the display 220 to display a completion screen as shown in FIG. 12E.

The completion screen of FIG. 12E may include the stage notification UI element 1221 as the screens of FIGS. 12B and 12D do. The stage notification UI element 1221 may notify that the third stage has been completed. In addition, the screen of FIG. 12E may include a UI element 1251 that notifies that reception of cooking data has been completed, and that the received cooking data can be edited or shared. Also the processor 230 may, in response to reception of cooking data being completed, control the display 220 to display a UI element 1252 for editing the received cooking data and a UI element 1253 for sharing the received cooking data with another electronic device. If no input is sensed for a predetermined period of time after the completion screen is displayed, or if a home screen return UI element 1254 is selected, the processor 230 may control the display 220 to display a home screen of the recipe App as shown in FIG. 12A.

The processor 230 may store the received cooking data in the storage 240 of the electronic device 200. In this case, the received cooking data may be stored in an excel file format. In the case where a plurality of pieces of cooking data is received from the cooking apparatus, the processor 230 may generate a group of cooking data including the plurality of pieces of the received cooking data in an excel file format, and store the generated group of cooking data in the storage 240.

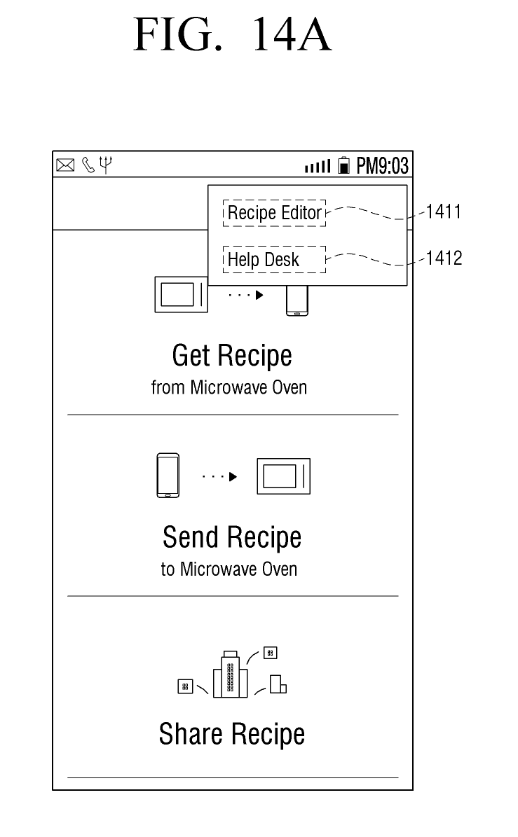

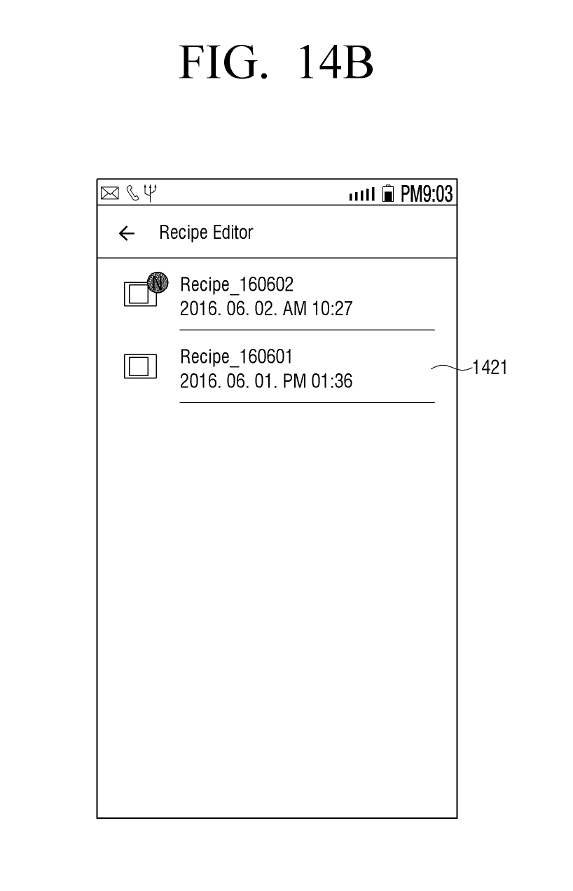

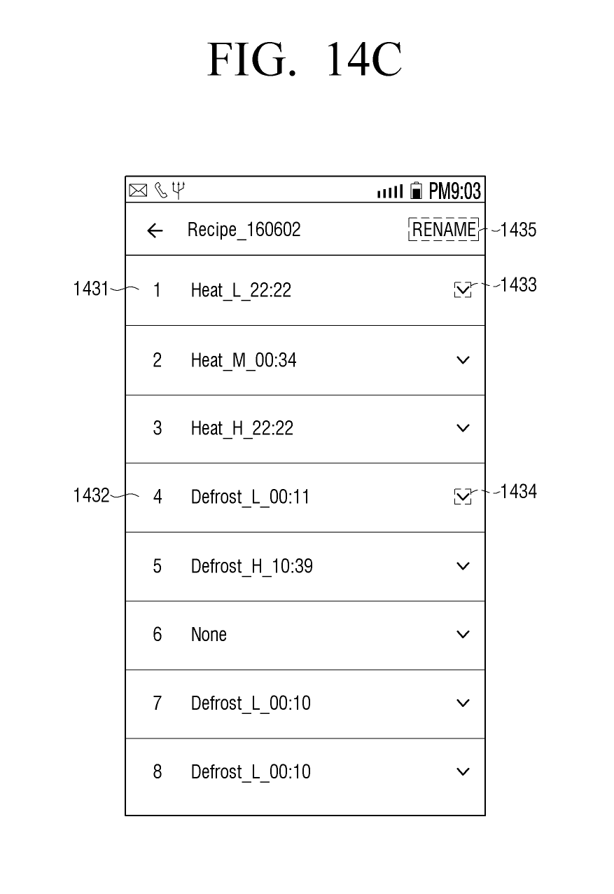

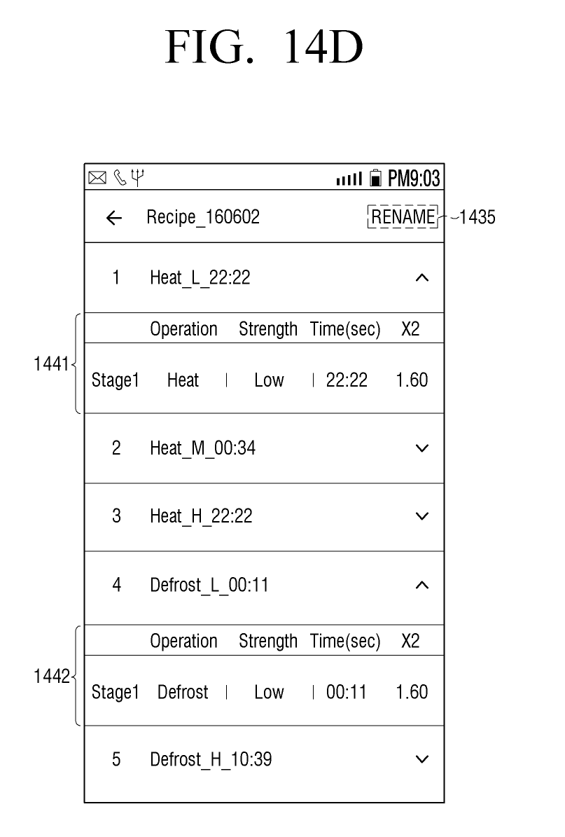

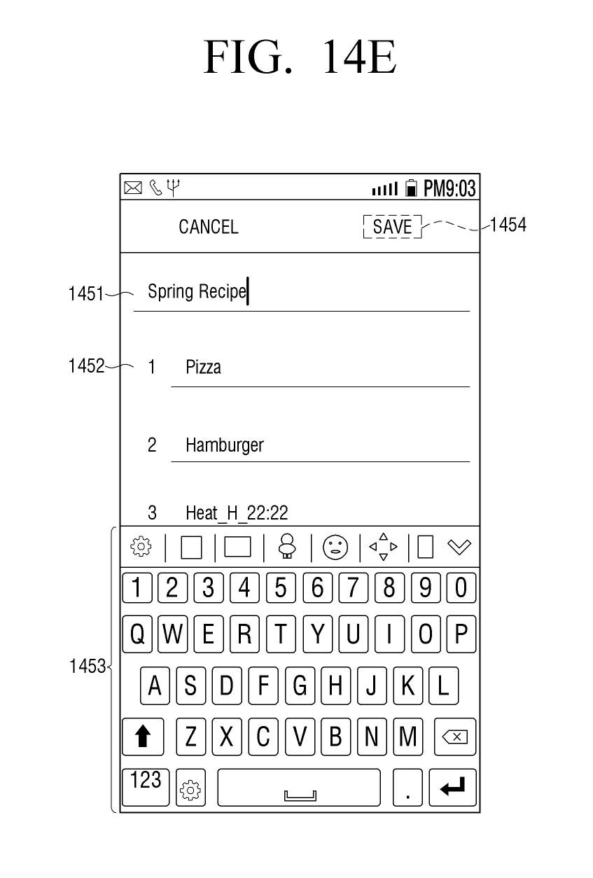

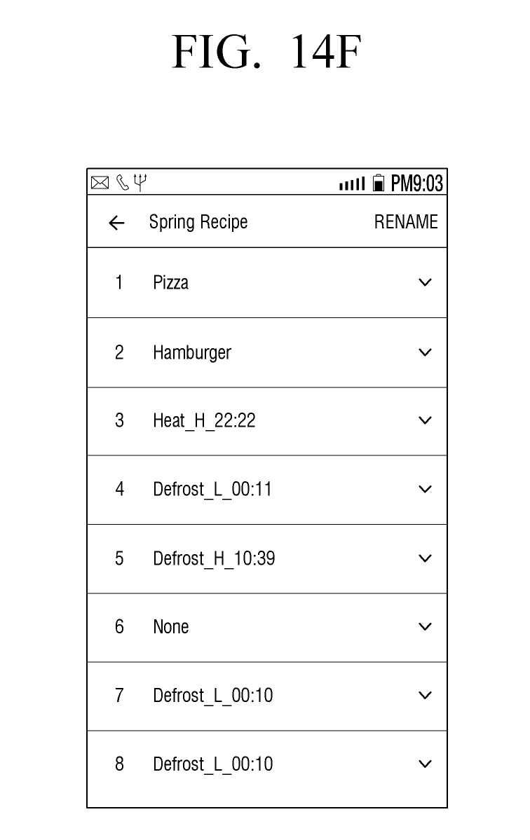

In response to the UI element 1252 for editing cooking data being selected, the processor 230 may control the display 220 to display the received cooking data, and the displayed screen may be the screen as shown in FIG. 14C. The editing of cooking data will be described in more detail with reference to FIGS. 14C and 14F.

The processor 230 may, in response to the UI element for sharing cooking data, which is displayed on the screen of FIG. 12E, being selected, display a UI screen for transmitting the received cooking data to another electronic device through the display 220. For example, the processor 230 may execute an email transmission application, and control the display 220 to display an email writing screen to which the received cooking data has been attached. Cooking data may be shared not only through an email but also through an MMS, an instant message, and the like. According to another example embodiment, a user may register at least one of an electronic device in advance, and in response to the UI element 1253 for sharing cooking data being selected, the processor 230 may control the communicator 210 to transmit the received cooking data to the pre-registered electronic device.

The stage notification UI element 1221 shown in FIGS. 12B-12E may have a different form. FIG. 12F is a diagram illustrating a different form of a stage notification UI element.

The stage notification UI element 1221 illustrated in FIGS. 12B-12E only notifies a current stage by filling up a circle with a color, the circle on which a number is displayed. However, the stage notification UI element in FIG. 12F may also display a progress rate of a current stage. To be specific, a circular progress bar may appear around the edge of the circle on which a number is displayed, and the progress bar shows a progress in a circular shape for N seconds after calculating a total time required to complete the stage.

As an example, referring to FIG. 12F, a circular progress bar may appear for about 6 seconds during the stage three, that is, the stage in which the electronic device 200 receives cooking data. In this manner, the circular progress bar may visually notify a user of a progress rate of a current stage and also visually notify that a user should wait for a while. Also, according to the UI as shown in FIG. 12F, a user may easily notice which of the stages are a current stage, and may also notice a state and a progress rate of each stage.

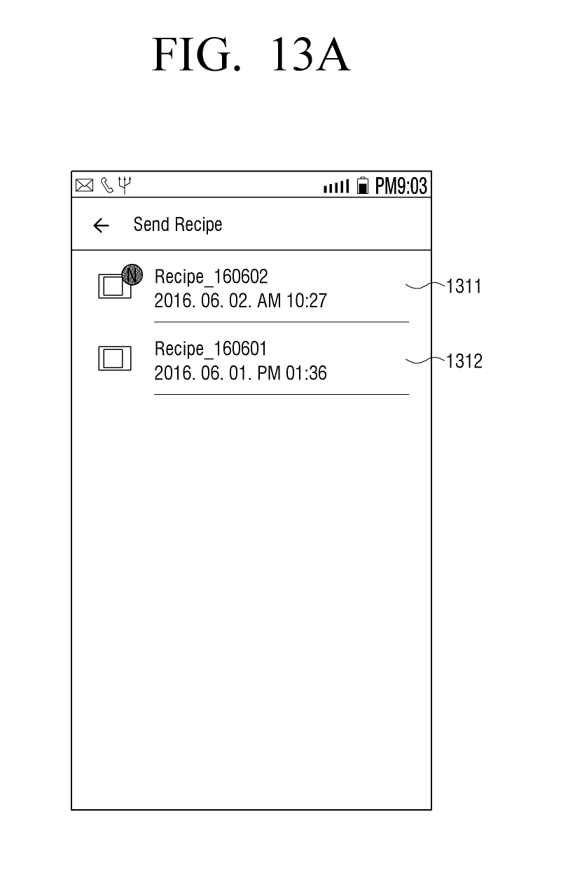

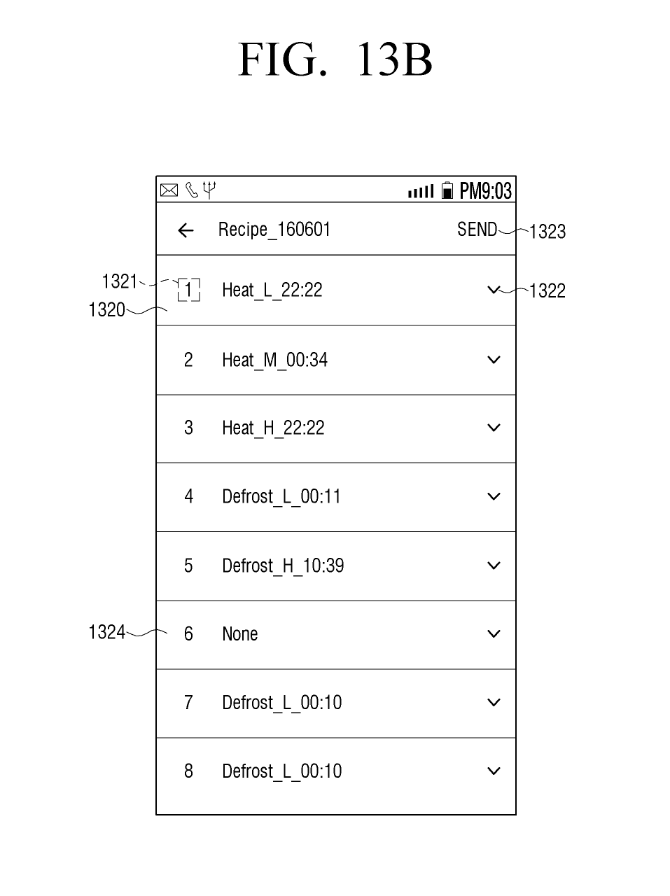

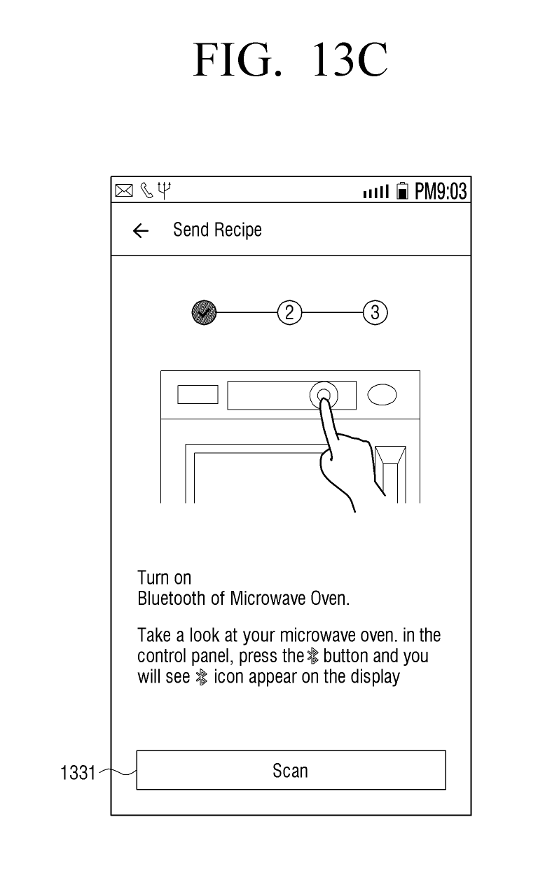

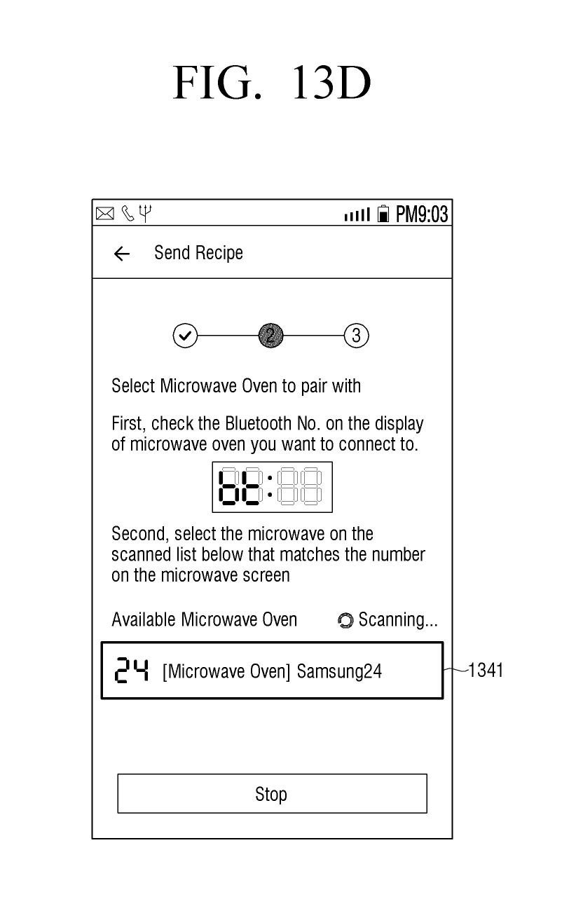

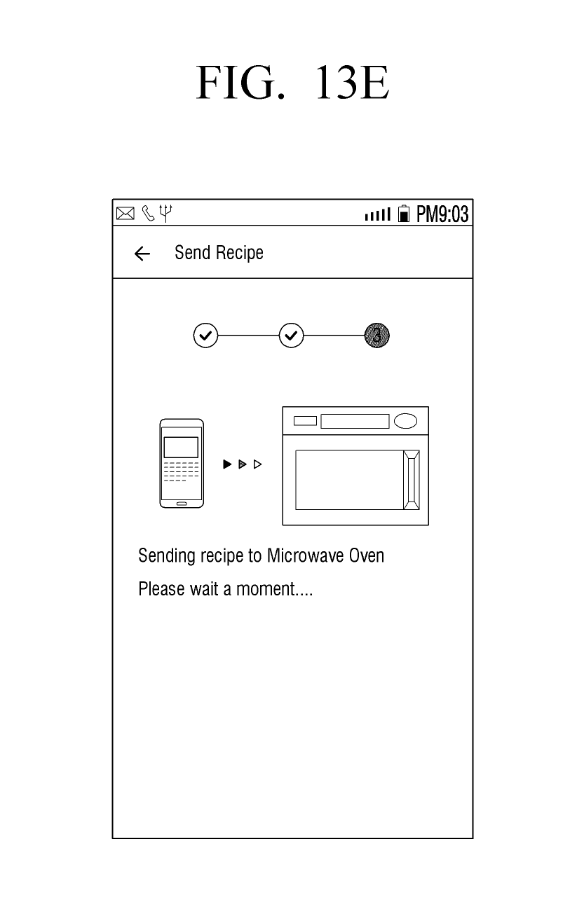

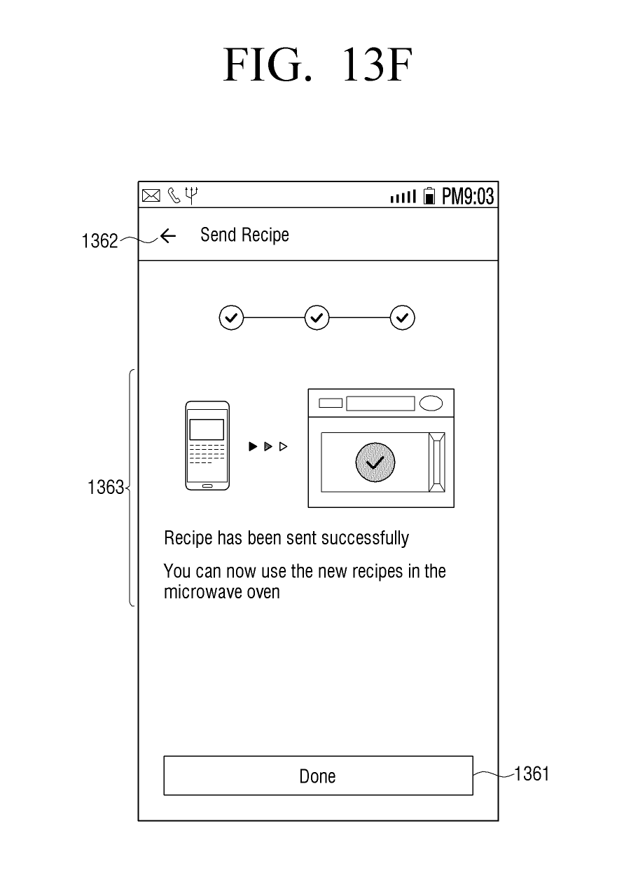

Hereinafter, an example embodiment in which the electronic device 200 transmits cooking data to the cooking apparatus 100 with reference to FIGS. 12A and 13A-13F.

FIG. 12A shows a home screen of the recipe App displayed on the display 220 when executing the recipe App.

Referring to FIG. 12A, the processor 230 may display a first UI element for receiving cooking data from a cooking apparatus, a second UI element for transmitting cooking data to a cooking apparatus and a third UI element for sharing cooking data with another electronic device, through the display 220.

The processor 230 may, in response to the second UI element 1212 being selected, control the display 220 to display at least one of pre-stored cooking data. In the storage 240 of the electronic device 200, pieces of cooking data may be stored separately, or a group of cooking data in which a plurality of pieces of cooking data are grouped may be stored.

FIG. 13A shows an example of a screen that may be displayed when the second UI element 1212 is selected. To be specific, the screen of FIG. 13A may include a first group of cooking data 1311 and a second group of cooking data 1312 that are stored in the storage 240 of the electronic device 200, and in the case of the newly-generated first group of cooking data 1311, “N” may also be displayed. The selected cooking data may be transmitted to the cooking apparatus.

In response to a cooking data being selected, the selected cooking data may be transmitted immediately, or specific information on the selected cooking data may be displayed. FIG. 13B shows a displayed screen when the second group of cooking data 1312 is selected.

The second group of cooking data 1312 may include a plurality of pieces of cooking data, and a list of the plurality of pieces of cooking data may be displayed on the screen as shown in FIG. 13B. In the case of selecting an enlargement UI element 1322, specific information (e.g., a cooking type, a cooking temperature, a cooking time, etc.) included in a first cooking data 1320 may be displayed.

A number 1321 may be assigned to each piece of cooking data. The number 1321 may be used to select a piece of cooking data in the cooking apparatus 100. In other words, in the case where the cooking apparatus 100 receives the first cooking data 1320 from the electronic device 200, if number 1 is selected through the input unit 350 of the cooking apparatus 100, the cooking apparatus 100 may perform cooking using the first cooking data 1320. There may be a number item to which cooking data is not assigned in the group of cooking data. Referring to FIG. 13B, cooking data has not been assigned to number 6, which is an item 1324. Accordingly, in the case where the cooking apparatus 100 has received the first cooking data 1320 from the electronic device 200, even if number 6 is selected through the input unit 350 of the cooking apparatus 100, the cooking apparatus 100 may not perform cooking because any cooking data has not been assigned to number 6.

If cooking type information included in the first cooking data 1320 is ‘Heat,’ cooking strength (or a cooking temperature) information is ‘Low,’ and cooking time information is ‘22 min:22 sec,’ a name of the cooking data 1320 in a cooking data list may be determined to be Heat_L_22:22 as shown in FIG. 13B. Meanwhile, if at least more than two cooking stages are included in cooking data (one cooking stage may be, for instance, composed of a cooking type, a cooking strength [or a cooking temperature] and a cooking time), a name of the cooking data may be determined using a cooking type, a cooking strength and cooking time of the first stage.

If a transmission button 1323 is selected while the electronic device is connected to the cooking apparatus 100, the second group of cooking data 1312 may be transmitted to the cooking apparatus 100. That is, a plurality of pieces of cooking data included in the second group of cooking data 1312 may be collectively transmitted to the cooking apparatus 100 at once.

If the transmission button 1323 is selected while there is no cooking apparatus connected, the processor 230 may control the display 220 to display a screen as shown in FIG. 13C. FIG. 13C shows a screen that explains a method for connecting to the cooking apparatus 100. The screen of FIG. 13C corresponds to FIG. 13B, and thus, the description for the elements of the screen of FIG. 13C that are overlapped with those of FIG. 12B will be omitted.

After a user selects the Bluetooth button 43 in the cooking apparatus 100, if the user selects a scan UI element 1331 displayed on a screen of FIG. 13C, the processor 230 may control the display 220 to display the screen as shown in FIG. 13D.

FIG. 13D shows a screen to receive a selection of a cooking apparatus to be connected. The screen of FIG. 13D corresponds to the screen of FIG. 12C, and thus, the description for the elements of the screen of FIG. 13D that are overlapped with those of FIG. 12C will be omitted.

On the screen of FIG. 13D, if a UI element 1341 corresponding to a retrieved cooking apparatus after searching for a cooking apparatus is selected, the processor 230 may control the communicator 210 to connect to the cooking apparatus corresponding to the selected UI element 1341.

The processor 230 may control the communicator 210 to transmit cooking data to the connected cooking apparatus, and control the display 220 to display a screen that notifies that the data is currently being transmitted as shown in FIG. 13E. The second group of cooking data 1312 has been selected on the screen of FIG. 13A, and the second group of cooking data 1312 may accordingly be transmitted to the cooking apparatus.

If the transmission of cooking data is completed, the processor 230 may control the display 220 to display a transmission completion screen as shown in FIG. 13F.

The screen of FIG. 13F may include a UI element 1363 and a completion button 1361 that notify that transmission of cooking data has been completed, and the transmitted cooking data is available to be used in the cooking apparatus. If the completion button 1361 is selected or a home screen return UI element 1362 is selected, the processor 230 may control the display 220 to display a home screen of a recipe App as shown in FIG. 12A.

Hereinafter, a method by which the electronic device 200 shares cooking data with another electronic device will be described.

FIG. 12A shows a home screen of a recipe App displayed on the display 220 when the recipe App is executed.

Referring to FIG. 12A, the processor 230 may display a first UI element 1211 for receiving cooking data, the second UI element 1212 for transmitting cooking data to a cooking apparatus and a third UI element 1213 for sharing cooking data with another electronic device, through the display 220.

The method for sharing cooking data with another electronic device may be similar to the method for transmitting cooking data to a cooking apparatus. For example, if the third UI element 1213 is selected, the processor 230 may display a list of cooking data stored in the electronic device 200, and transmit the cooking data selected from the list to another electronic device. If another device is located near the electronic device 200, the selected cooking data may be transmitted by a near-field wireless communication method, which is the same method as the method for transmitting cooking data to the cooking apparatus, such as Bluetooth, NFC, Wi-Fi Direct or the like. Or, the cooking data may be attached to an email, an MMS, an instant message, etc., and transmitted to another electronic device.

Also, as described with reference to FIG. 2, if cooking data is shared between a headquarter and a plurality of branches, it is convenient to pre-register an electronic device of the branches with which cooking data will be shared. Therefore, according to an example embodiment, at least one electronic device with which cooking data is shared may be registered in advance. For example, referring to FIG. 2, the electronic device of the headquarter 200-1 may register the electronic devices 200-2, 200-3 and 200-4 of branches in advance. If the third UI element 1213 is selected on the home screen of FIG. 12A, the processor 230 may display at least one cooking data stored in the electronic device 200 as shown in FIG. 13A, and control the communicator 210 to transmit cooking data selected from among at least one cooking data to at least one pre-registered electronic device.

Hereinafter, referring to FIGS. 12A and 14A-14F, a method for editing cooking data stored in the electronic device 200 will be described.

FIG. 12A shows a home screen of the recipe App that is displayed on the display 220 when the recipe App is executed.

Referring to FIG. 12A, the home screen of the recipe App may include a context menu 1214. When the context menu 1214 is selected, the processor 230 may display a UI element 1411 for editing cooking data and a help-desk UI element 1412. If the help-desk UI element 1412 is selected, information on the place to which a user can inquire about the use of the recipe App, or information on the place to which a user can inquire about the use of the cooking apparatus may be displayed.

If the UI element 1411 for editing cooking data is selected, the processor 230 may control the display 220 to display cooking data stored in the storage 240 of the electronic device 200. As an example, the screen of FIG. 14B may be displayed. The screen of FIG. 14B corresponds to the screen of FIG. 13A, and thus, the description for the overlapped elements will be omitted.

If a user selects the second group of cooking data 1421 as cooking data that a user wants to edit, a screen of a list of cooking data included in the second group of cooking data 1421 may be displayed on the display 220. The screen of FIG. 14C may correspond to the screen of FIG. 13B, and thus, the description for the overlapped elements may be omitted.

A user may see specific information included in cooking data. For example, if a first enlargement UI element 1433 that corresponds to first cooking data 1431 is selected, the processor 230 may display specific information 1441 included in first cooking data 1431 on the display 220 as shown in FIG. 14D. Also, if a second enlargement UI element 1434 that corresponds to second cooking data 1432 is selected, the processor 230 may display specific information 1442 included in the second cooking data 1432 on the display 220 as shown in FIG. 14D.

If a UI element for editing 1435 is selected, a name of cooking data may become a state in which the name can be edited as shown in FIG. 14E, and a soft keyboard 1453 may be displayed. A user may edit a name of the second group of cooking data 1421 from ‘Recipe_160602’ to ‘Spring Recipe’ through the soft keyboard 1453, and edit a name 1452 of the first cooking data 1431 included in the second group of cooking data 1421 from ‘Heat_L_22:22’ to ‘Pizza.’

Not only names of cooking data but information such as a cooking type, a cooking strength, etc. may also be edited.

If a UI element for storing 1454 is selected on a screen of FIG. 14E, the processor 230 may store the edited cooking data in the storage 240 of the electronic device 200. After editing is completed, the processor 230 may display a screen in which the editing is reflected as shown in FIG. 14F.

Besides the UI element for editing cooking data in FIG. 14A, cooking data may be edited when a UI element 1252 for editing cooking data on a screen of FIG. 12E, the screen that is displayed when reception of cooking data from the cooking apparatus is completed. For example, if a plurality of pieces of cooking data are received from the cooking apparatus, a group of cooking data is generated, and the UI element 1252 for editing in FIG. 12E is selected, a screen on which the group of cooking data can be edited may be displayed as shown in FIG. 14C.

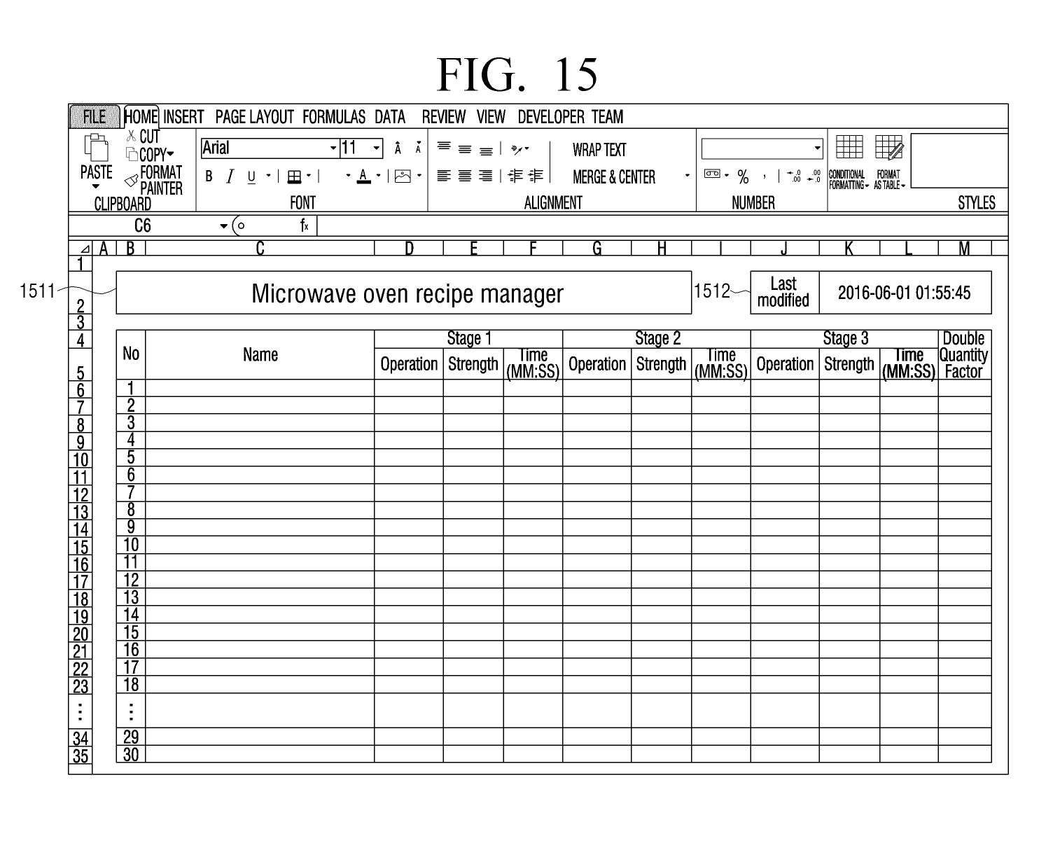

Cooking data may be stored in an excel file format. FIG. 15 shows an example of a structure of an excel file in which cooking data is stored. To be specific, FIG. 15 illustrates a structure of an excel file of a group of cooking data in which a plurality of pieces of cooking data may be grouped.

Referring to FIG. 15, a certain phrase is basically recited in a certain cell. For example, the phrase ‘Microwave oven recipe manager’ may be recited in cells B2-H2 (1511), and ‘Last modified’ may be recited in cell J2 (1512). The processor 230 may determine whether or not a corresponding excel file is a cooking data file base on the determination of whether or not a certain phrase is recited in a certain cell. Therefore, if a user needs to see cooking data in the electronic device 200, the processor 230 may analyze whether a certain phrase is included in a certain cell as described above, and display only an excel file that has been determined as cooking data file on the display 220. For example, if a screen of FIG. 13A or FIG. 14B is displayed, the processor may not display all excel files stored in the electronic device 200, but analyze contents of excel files and display only the file that is a cooking data file format.

In this manner, when transmitting cooking data to a cooking apparatus, the data that is not cooking data may not be transmitted.

Meanwhile, even though a file is determined as having a cooking data file format because a certain phrase is recited in a certain cell in the file, if a specific cooking value is not appropriate, that is, in FIG. 15, a time phrase such as ‘MM: SS’ should be recited in cell F6, but if a different form of a time phrase is recited in the cell, and such invalid cooking data is transmitted to a cooking apparatus and used in cooking, an error may occur in the cooking apparatus. To prevent this, the processor may determine whether or not a cooking value included in cooking data is valid before transmitting the cooking data to the cooking apparatus.

For example, if the second UI element 1212 of FIG. 12A is selected, the processor 230 may display a list of at least one pre-stored cooking data as shown in FIG. 13A, and if one cooking data is selected from among the pre-stored cooking data, that is, if the first group of cooking data 1311 is selected, and a value included in the first group of cooking data 1311 is not valid, the processor 230 may control the display 220 to display an error message. If the value included in the selected first group of cooking data 1311 is valid, the processor may control the communicator 210 to transmit the first group of cooking data 1311 to the cooking apparatus.

The error message may include text such as “cooking data is invalid.” Further, the processor 230 may control the display 220 to display a UI element for editing the selected first group cooking data 1311 along with the error message. If the display UI element is selected, the processor 230 may display a screen as shown in FIG. 14C, or display an excel file with a format illustrated in FIG. 15. A user may edit an invalid cooking value accordingly.

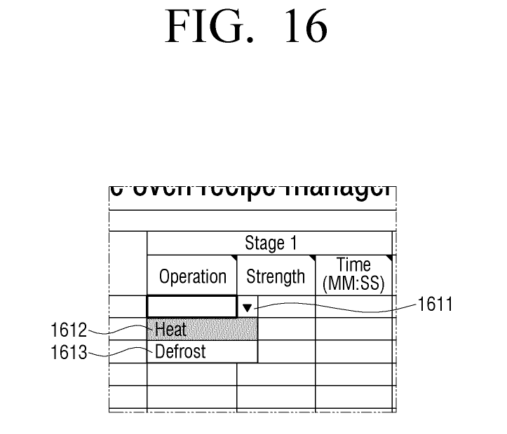

Meanwhile, only a value that is allowed to be input in a respective cell may be displayed in a form of a drop box in an excel file as shown in FIG. 16 so as to prevent an invalid value being included in cooking data. FIG. 16 is an enlarged view of a portion of an excel file illustrated in FIG. 15. For example, if only ‘Heat’ and ‘Defrost’ are valid values as a cooking type (Operation), the processor 230 may display only Heat 1612 and Defrost 1613 when the drop box 1611 is selected.

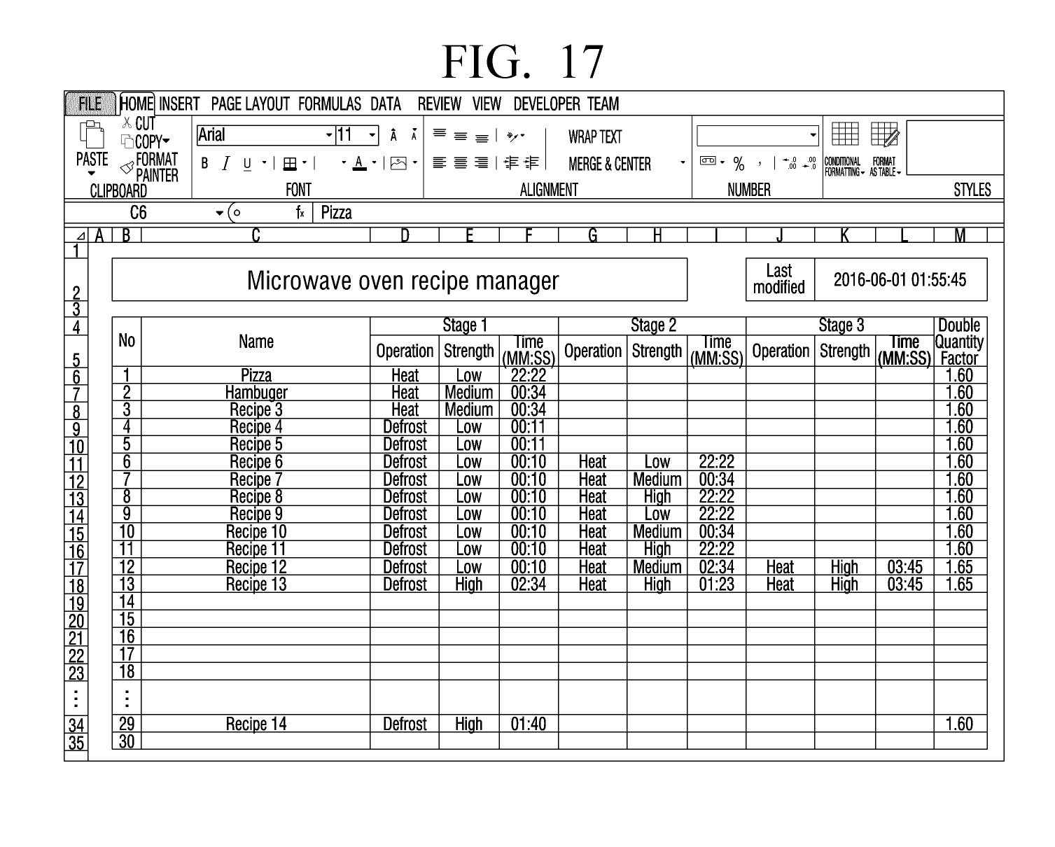

FIG. 17 shows an example embodiment of a group of cooking data stored in the electronic device 200.

Referring to FIG. 17, each cooking data may occupy each row in the excel file, and cooking data in each row may include a plurality of stages. To be specific, with reference to row 11, a name of cooking data matched to number 6 is ‘Recipe 6,’ and in the first stage, a cooking type is ‘Defrost,’ a cooking strength (or a cooking temperature) is ‘Low’ and a cooking time is 10 seconds. Also, in a second stage, a cooking type is ‘Heat,’ a cooking strength is ‘Low’, and a cooking time is 22 minutes 22 seconds. A double quantity factor (multiples of a cooking strength when large quantity of food is cooked at once) is 1.60.

According to an example embodiment, the number of pieces of cooking data that can be set in the cooking apparatus 100 is 30, and 30 pieces of cooking data may be set by receiving a group of cooking data corresponding to the excel file illustrated in FIG. 17. Even though cooking data has been stored in the cooking apparatus 100, the stored cooking data may be replaced with the received group of cooking data.

In the case where the group of cooking data corresponding to the excel file of FIG. 17 has been transmitted to the cooking apparatus 100, when number 6 is input in the cooking apparatus 100, and cooking is performed with cooking data corresponding to number 6, defrosting is carried out in a cooking strength of ‘Low’ for 10 seconds. After that, heating is carried out in a cooking strength ‘Low’ for 22 minutes 22 seconds, and the double quantity factor is set to 1.60. Meanwhile, in the excel file of FIG. 17, there is no cooking data matched to numbers 14-28, and therefore, even if any of these numbers are input in the cooking apparatus, cooking that is performed based on cooking data may not be performed.

If cooking data is transmitted from the electronic device 200 to the cooking apparatus 100, only the values such as HEAT, LOW, etc. may be obtained from a file illustrated in FIG. 17, and transmitted to the cooking apparatus 100.

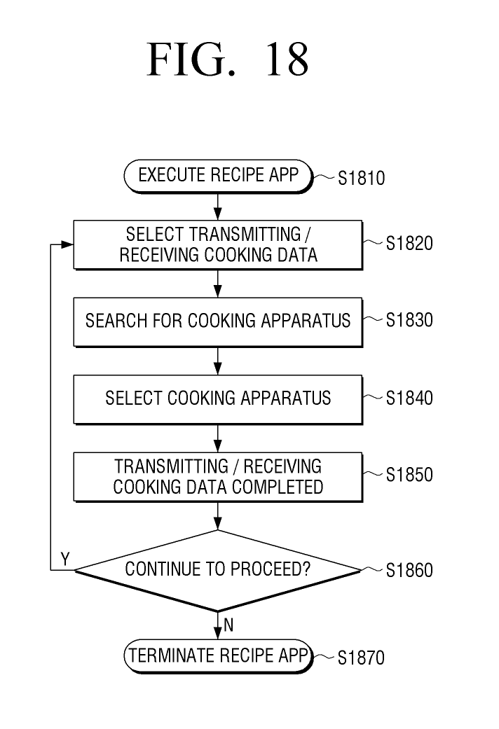

FIG. 18 is a flowchart illustrating a method for transmitting and receiving cooking data in an electronic device.

Referring to FIG. 18, the electronic device 200 may firstly execute the recipe App (S1810).

In response to executing the recipe App, a UI screen including a UI element for transmitting cooking data and a UI element for receiving cooking data may be displayed.

The electronic device 200 may receive a selection of a UI element for transmitting cooking data or a UI element for receiving cooking data.

Then, the electronic device 200 may search for nearby cooking apparatuses through wireless near-field communication. Bluetooth communication may be used as the wireless near-field communication.

The cooking apparatus 100 may also supports wireless near-field communication such as Bluetooth communication. A user may execute the wireless near-field communication by manipulating the input unit of the cooking apparatus 100. For example, a user may select the Bluetooth button 43 in FIG. 4. Through the manipulation, the electronic device 200 may search for the cooking apparatus 100.

The electronic device 200 may display retrieved cooking apparatuses through the display 220, and receive a selection of a cooking apparatus that a user wants from among the displayed cooking apparatuses. One cooking apparatus may be selected, or equal to or more than two cooking apparatuses may also be selected.

Then, the electronic device 200 may transmit cooking data to the selected cooking apparatus, or may receive cooking data from the selected cooking apparatus (S1850). When transmission or reception of cooking data is completed, a near-field wireless communication function may be automatically inactivated in the corresponding cooking apparatus.

The electronic device may receive a selection of whether to continue to proceed (S1860). If a user selects to continue to proceed, the electronic device 200 may display a UI screen including the UI element for transmitting cooking data and the UI element for receiving cooking data, and receive a selection of transmitting cooking data or receiving cooking data. If a user does not select to continue to proceed, the electronic device 200 may terminate the recipe App (S1870).

Meanwhile, in FIG. 18, it has been described that, after stage S1820 of receiving a selection of transmitting cooking data or receiving cooking data, stage S1830 of searching for a cooking apparatus and stage S1840 of receiving a selection of a cooking apparatus may be proceed. However, stages may be proceeded in an order of stage S1830 of searching for a cooking apparatus, stage S1840 of receiving a selection of a cooking apparatus and stage S1820 of receiving a selection of transmitting cooking data or receiving cooking data, or in an order of stage S1830 of searching for a cooking apparatus, stage S1820 of receiving a selection of transmitting cooking data or receiving cooking data and stage S1840 of receiving a selection of a cooking apparatus.

Also, a cooking apparatus may be automatically selected even if a user does not select a cooking apparatus. For example, a nearest cooking apparatus can be automatically selected, or a cooking apparatus that has been mostly connected can be automatically selected, or if only one cooking apparatus is retrieved after searching, the cooking apparatus can be automatically selected. Therefore, stage S1840 of receiving a selection of a cooking apparatus from a user may be skipped if desired.

A Bluetooth device in general has its own device name. If Bluetooth communication is commenced in stage S1830 of searching for a cooking apparatus, Bluetooth of the cooking apparatus may be searched by the apparatus name of the cooking apparatus on the electronic device 200. In this case, a cooking apparatus may not have a fixed apparatus name. For example, an apparatus name of the cooking apparatus may be “[Microwave Oven] SamsungXX.” The “[Microwave Oven] Samsung” may be fixed, but “XX” may be changed and be a number between 00 and 99. The number may be a random number generated by the cooking apparatus whenever Bluetooth communication is initiated in the cooking apparatus, and the number may be displayed on a display of the cooking apparatus. For instance, as illustrated in FIG. 10, the cooking apparatus may display number ‘33’.

The reason why a random number is displayed is to identify each cooking apparatus using the displayed number if there are more than two cooking apparatuses. A user may determine whether it is a same cooking apparatus by comparing an apparatus name displayed on the electronic device 200 with a number displayed on the display 340 of the cooking apparatus 100. FIG. 11 shows an example of the number displayed on the electronic device 200. In FIG. 11, if number 33 displayed on the electronic device 200 is identical to number 33 displayed on the cooking apparatus 100, the cooking apparatus is the same apparatus.

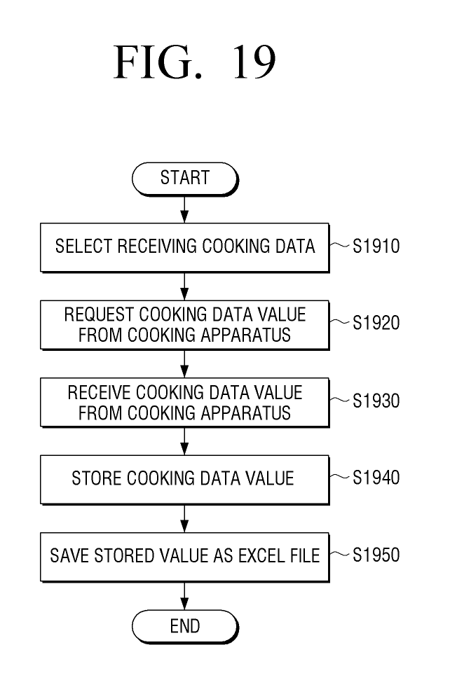

FIG. 19 is a flowchart illustrating a method by which an electronic device receives cooking data according to an example embodiment.

Referring to FIG. 19, firstly, the electronic device 200 may receive a selection of a UI element for receiving cooking data on the screen illustrated in FIG. 12A (S1910).

The electronic device 200 may request a cooking data value from the cooking apparatus 100 (S1920). Only several pieces of cooking data or all pieces of cooking data stored in the cooking apparatus 100 may be requested. If all pieces of cooking data are requested, all the pieces of cooking data may be received by requesting the data one by one, so that all the pieces of cooking data may be received collectively at one request.

If it is assumed that the cooking apparatus may store up to 30 pieces of cooking data, the electronic device 200 may receive all 30 pieces of cooking data by requesting the data one by one. The actually received data may be a cooking type, a cooking strength and a cooking time.

The electronic device 200 may receive a requested cooking data value from the cooking apparatus (S1930). If whole cooking data is requested, the whole cooking data may be received, and if portion of cooking data is requested, the portion of cooking data may be received.

The electronic device 200 may store the received cooking data value (S1940). For example, a value corresponding to a cooking type, a value corresponding to a cooking strength and a value corresponding to a cooking time may be stored in the storage.

When transmission of data requested by the electronic device 200 is completed, the electronic device 200 may store the cooking data value stored in the storage in an excel file format. A basic format of an excel file (please see FIG. 16) may be stored in the recipe App in advance, and may be stored when the recipe App is installed. The recipe App may import the basic format file and record appropriate data such as a cooking time or a cooking strength in each cell, and store the file through the method for storing a file in the storage. When storing the file, a name of the file may be a current date.

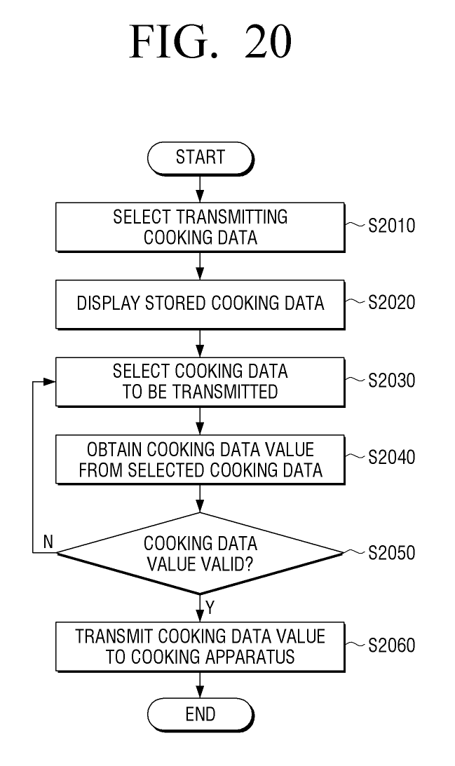

FIG. 20 is a flowchart illustrating a method by which an electronic device transmits cooking data according to an example embodiment.

Referring to FIG. 20, firstly, the electronic device 200 may receive a selection of a UI element for transmitting cooking data on the screen illustrated in FIG. 12A in operation S2010.

Before transmitting cooking data, a selection process in which a user selects data that the user wants to transmit may be required. In order to proceed with the selection process, all cooking data files stored in the electronic device 200 may be displayed on the display 220. The cooking data file may be an excel file.

However, the electronic device 200 should not display all the excel files stored in the electronic device 200. Therefore, the electronic device 200 may analyze contents of an excel file, determine whether or not the format of the file is a cooking data file format, and display the file only when the excel file is a cooking data file format. As the basic excel file format is provided (please see FIG. 16), it should be checked whether the basic format of the file is an appropriate excel file format. For example, a checking process of whether a certain phrase is recited in a certain cell may be carried out. The reason why the checking process is required is to avoid unnecessarily including an excel file that is not a cooking data file in a cooking data file list in the recipe App. Meanwhile, if no cooking data file is present in the electronic device 200, the electronic device 200 may notify a user that there is no cooking data file in the electronic device 200.

The cooking data to be transmitted may be selected from among the displayed cooking data list in operation S2030.

The electronic device 200 may analyze the selected cooking data file (an excel file), and obtain a cooking data ‘value’ in operation S2040.

Then, the electronic device 200 may determine whether the obtained cooking data value is valid. The determination is carried out to prevent that cooking data having an invalid cooking data value is transmitted to the cooking apparatus 100 and causes a malfunction. For example, a cooking time should be input in a form of minutes and seconds such as MM:SS, a cooking type should be input in a word such as ‘Defrost’ and ‘Heat,’ and a cooking strength may be input in a word indicating a heat strength such as ‘Low,’‘Medium’ and ‘High.’ The electronic device 200 may determine the cooking data that includes a value having a form other than the aforementioned forms as including an invalid value. For example, if a value such as text or a special character is input in a cell in which a number should be input, it may be determined that the cell includes an invalid value. In addition, according to an example embodiment, the electronic device 200 may, if cooking data including an invalid value is selected, indicate which of values of cells are invalid. Therefore, the electronic device 200 may notify a user that the cell includes an invalid value, and further notify which values are invalid, specifically.

Then, the electronic device 200 may transmit the obtained cooking data value to the cooking apparatus in operation S2060. In other words, the electronic device 200 may not transmit an excel file to the cooking apparatus, but transmit a relevant value stored in the excel file.

As in the example in which the electronic device 200 receives cooking data, the electronic device 200 may transmit only one piece of cooking data, or transmit all pieces of cooking data at once or sequentially to the cooking apparatus 100. As an example, 30 pieces of cooking data may be set in the cooking apparatus 100, and thus, the electronic device 200 may sequentially transmit a plurality of pieces of cooking data to the cooking apparatus 100 by 30 pieces of cooking data at a time. Then, the cooking apparatus 100 may receive the 30 pieces of cooking data, and perform writing of the received cooking data value. That is, the cooking apparatus 100 may replace (or update) the existing thirty pieces of cooking data with the newly received thirty pieces cooking data.

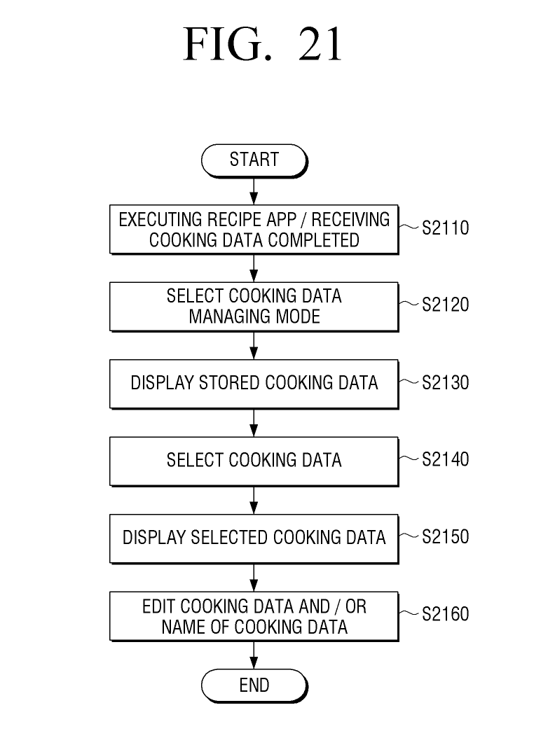

FIG. 21 is a flowchart illustrating a method for seeing and editing cooking data in an electronic device according to an example embodiment.

Referring to FIG. 21, firstly, in the electronic device 200, the recipe App may be executed by a user manipulation, or reception of cooking data from the cooking apparatus 100 or another electronic device may be completed in operation S2110. In the case where the recipe App is executed by a user manipulation, the screen illustrated in FIG. 12A may be displayed. In the case where reception of cooking data from the cooking apparatus 100 or another electronic device is completed, the screen illustrated in FIG. 12E may be displayed.

The electronic device 200 may receive a selection of a cooking data managing mode in operation S2120. As an example, the process in which the managing mode is selected may be, if the recipe APP is executed and the screen illustrated in FIG. 12A is displayed, a process of receiving a selection of the UI element 1411 for editing cooking data on the screen illustrated in FIG. 14A, the screen that is displayed in response to receiving a selection of the context menu 1214. Or, if reception of cooking data is completed, and the screen illustrated in FIG. 12E is displayed, the process may be of receiving a selection of the UI element 1252 for editing the received cooking data.

The electronic device 200 may display all cooking data files stored in the electronic device 200 through the display 220 in operation S2130. This stage may correspond to operation S2020 that has been described with reference to FIG. 20.

Then, the electronic device may receive a selection of the cooking data that a user wants to edit in operation S2140. This stage may correspond to operation S2030 that has been described with reference to FIG. 20.

The electronic device 200 may display the selected cooking data in operation S2150. For example, an excel file illustrated in FIG. 17 may be displayed, or a cooking data list may be displayed as illustrated in FIG. 14C.

The electronic device 200 may edit a name of cooking data according to a user manipulation, and may also edit a value included in cooking data. For example, in the screen of FIG. 14C or FIG. 14D, if a UI element for editing 1435 is selected, a screen on which a name can be edited may be displayed as in FIG. 14E, and specific information (1441, 1442) included in cooking data may be edited on the screen illustrated in FIG. 14D. Further, values included in each cell of the excel file illustrated in FIG. 17 may be edited.

The edited information may be stored in the electronic device 200, and be displayed through the electronic device 200.

According to the foregoing various example embodiments, cooking data used in cooking in the cooking apparatus may be effectively managed and shared.

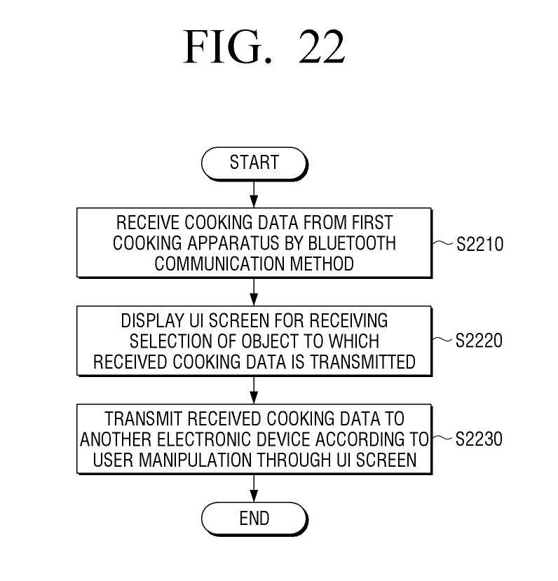

FIG. 22 is a flowchart illustrating a method for controlling an electronic device 200 according to another example embodiment.

Referring to FIG. 22, firstly, the electronic device 200 may receive cooking data from the first cooking apparatus by a Bluetooth communication method in operation S2210. The Bluetooth communication method may be a Bluetooth Low Energy (BLE) method.

In the electronic device 200, a recipe application may be stored, and if the recipe application is executed, the electronic device 200 may display a first UI element for receiving cooking data from a cooking apparatus, a second UI element for transmitting cooking data to a cooking apparatus and a third UI element for sharing cooking data with another electronic device. For example, the screen illustrated in FIG. 12A may be displayed.

If the second UI element or the third UI element is selected, the electronic device 200 may display information on at least one piece of pre-stored cooking data. For example, the screen illustrated in FIG. 13A may be displayed.

If the first UI element is selected, the electronic device 200 may display at least one cooking apparatus to which the electronic device 200 is connected. For example, when the first UI element is selected, the electronic device 200 may search for nearby cooking apparatuses by a Bluetooth communication method, and may display at least one retrieved cooking apparatus. Then, if a cooking apparatus is selected from among the at least one displayed cooking apparatus, the electronic device 200 may receive cooking data from the selected cooking apparatus.

The electronic device 200 may display a UI screen for receiving a selection of an object to which the received cooking data is transmitted in operation S2220. Then, the electronic device 200 may transmit the received cooking data to another electronic device according to a user manipulation through the UI screen in operation S2230.

The UI screen may include a result of searching for another nearby electronic device by a Bluetooth communication method. For example, the UI screen may be the screen illustrated in FIG. 13D. A user may select, through the UI screen, a cooking apparatus to which cooking data is transmitted, and the electronic device 200 may transmit cooking data to the selected cooking apparatus by a Bluetooth communication method.

According to another example embodiment, the UI screen may be for transmitting cooking data by at least one of an email, an instant message and a multimedia messaging service (MMS), and a user may transmit cooking data to a plurality of other users through the UI screen, and share cooking data. For example, the electronic device 200 may attach cooking data to at least one of an email, an instant message and an MMS according to a user manipulation through the UI screen, and transmit cooking data.

The above-described various embodiments may be implemented in a recording medium that is readable by a computer or a similar device using software, hardware, or a combination of these. According to hardware implementation, the embodiments described in the present disclosure may be implemented by using at least one of ASICs, digital signal processors (DSPs), digital signal processing devices (DSPDs), programmable logic devices (PLDs), field programmable gate arrays (FPGAs), processors, controllers, micro controllers, microprocessors, and an electric unit for performing other functions. According to software implementation, the embodiments of the procedure and the functions described in the present disclosure may be implemented by using separate software modules. Each of the software modules may perform one or more functions and one or more operations described in the present disclosure.

The method of controlling an electronic device or of a cooking apparatus according to various example embodiments described above may be implemented in a program so as to be provided to the electronic device or the cooking apparatus. Particularly, the program including the aforementioned method of controlling an electronic device or of a cooking apparatus according to various example embodiments may be stored in a non-transitory computer readable medium and provided.

A non-transitory computer readable medium is a medium that does not store data during a short-term such as a register, a cache, a memory and the like, but semi-permanently stores data, and may perform a reading through a device. To be specific, the programs for performing the various methods described above may be stored in and provided through a non-temporary reading device such as a CD, a DVD, a hard disk, Blu-Ray, a disk, an USB, a memory card, a ROM and the like.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A cooking apparatus comprising:
a cooking compartment in which food is placed;
a control substrate configured to receive an input of user manipulation;
a communicator configured to receive cooking data from an external electronic device by a wireless communication method, and be mounted on a backside of the control substrate; and
a processor configured to perform cooking based on at least one of the user manipulation input through the control substrate and the received cooking data.

2. The cooking apparatus of claim 1, wherein the wireless communication method is at least one of: NFC, Wi-Fi or Bluetooth.

3. The cooking apparatus of claim 1 further comprising:
a display configured to, in response to a control command for connecting to an external electronic device being input, display a random number,
wherein the processor transmits information corresponding to the displayed random number to the external electronic device through the communicator.

4. The cooking apparatus of claim 1 further comprising:
a storage configured to store a plurality of pieces of cooking data and information on a plurality of numbers mapped to each of the plurality of pieces of cooking data,
wherein the processor, in response to a number being input through the control substrate, performs cooking using cooking data mapped to the input number among the plurality of pieces of cooking data.

5. The cooking apparatus of claim 1, wherein the received cooking data includes information on a cooking type, a cooking temperature and a cooking time.

6. The cooking apparatus of claim 4, wherein the communicator is further configured to receive cooking data and information on a number mapped to the cooking data from the external electronic device, and
wherein the processor is further configured to replace cooking data mapped to a number corresponding to the received information on the number among the plurality of pieces of cooking data stored in the storage, with the received cooking data.

7. The cooking apparatus of claim 4, wherein the processor is further configured to, in response to receiving a request for cooking data from the external electronic device, control the communicator to transmit the plurality of pieces of cooking data and information on a plurality of numbers mapped to each of the plurality of pieces of cooking data to the external electronic device.

8. The cooking apparatus of claim 1, wherein the processor is further configured to:
control a communication function not to be performed while cooking is performed, and
control cooking not to be performed while a communication function is performed.

9. A cooking apparatus comprising:
a cooking compartment in which food is placed;
a communicator configured to transmit cooking data to, and receive cooking data from, an external electronic device by a Bluetooth communication method; and
a processor configured to:
control the communicator to receive cooking data from the external electronic device or to transmit pre-stored cooking data to the external electronic device, and
perform cooking based on the pre-stored cooking data or the received cooking data.

10. A method for controlling a cooking apparatus comprising a cooking compartment in which food is placed, the method comprising:
receiving cooking data from an external electronic device by a Bluetooth communication method;
performing cooking based on the received cooking data or pre-stored cooking data; and
transmitting the pre-stored cooking data to the external electronic device by a Bluetooth communication method.

11. A cooking system comprising:
a cooking apparatus configured to generate cooking data according to a user input; and
an electronic device configured to receive the generated cooking data from the cooking apparatus,
wherein the cooking apparatus is further configured to transmit the generated cooking data to the electronic device by a Bluetooth communication method.

12. The cooking system of claim 11, wherein the cooking data includes information on a cooking type, a cooking temperature and a cooking time.

13. A cooking system comprising:
an electronic device configured to store cooking data; and
a cooking apparatus configured to:
receive cooking data from the electronic device by a Bluetooth communication method, and
perform cooking based on the received cooking data.

14. The cooking system of claim 13, wherein the cooking data includes information on a cooking type, a cooking temperature and a cooking time.

15. A cooking system comprising:
a first cooking apparatus configured to generate cooking data according to a user input;
an electronic device configured to receive the generated cooking data from the first cooking apparatus by a Bluetooth communication method; and
a second cooking apparatus configured to:
receive the generated cooking data from the electronic device by a Bluetooth communication method, and
perform cooking based on the received cooking data.

16. The cooking system of claim 15, wherein the electronic device comprises:
a communicator configured to communicate with the first cooking apparatus and the second cooking apparatus;
a display configured to:
display a first UI element for receiving cooking data from the first cooking apparatus,
display a second UI element for transmitting cooking data to the second cooking apparatus, and
display a third UI element for sharing cooking data with another electronic device; and
a processor configured to, in response to the first UI element being selected, control the communicator to receive cooking data from the first cooking apparatus.

17. The cooking system of claim 16, wherein the processor is further configured to:
in response to the second UI element being selected, display at least one of pieces of pre-stored cooking data, and
in response to a piece of cooking data being selected from among at least one piece of the displayed cooking data and a value included in the selected cooking data being invalid, control the display to display an error message.

18. The cooking system of claim 17, wherein the processor is further configured to control the display to display an UI element for editing the selected cooking data along with the error message.

19. The cooking system of claim 17, wherein the processor is further configured to, in response to a value included in the selected cooking data being valid, control the communicator to transmit the selected cooking data to the second cooking apparatus.

20. The cooking system of claim 16, wherein the communicator is further configured to receive information on a number displayed on a display panel of the first or the second cooking apparatus from the first or the second cooking apparatus, and
wherein the processor is further configured to:
control the display to display a fourth UI element including a number corresponding to the received information on the number, and
in response to the fourth UI element being selected, control the communicator to connect to the first or the second cooking apparatus.

21. The cooking system of claim 16, wherein the processor is further configured to:
in response to the third UI element being selected, control the display to display at least one piece of pre-stored cooking data, and
control the communicator to transmit the cooking data selected from among at least one piece of the displayed cooking data to at least one of other pre-registered electronic devices.

22. The cooking system of claim 16, wherein the processor is further configured to, in response to completing reception of cooking data from the first cooking apparatus, control the display to display a UI element for sharing the received cooking data with another electronic device and an UI element for editing the received cooking data.

23. The cooking system of claim 15, wherein the electronic device is further configured to, in response to receiving a plurality of pieces of cooking data from the first cooking apparatus, generate a group of cooking data including the plurality of pieces of received cooking data in an excel file format.

24. A method for controlling an electronic device, the method comprising:
receiving cooking data from a first cooking apparatus by a Bluetooth communication method;
displaying a UI screen for receiving a selection of an object to which the received cooking data is transmitted; and
transmitting the received cooking data to another electronic device according to a user manipulation through the UI screen.

25. The method of claim 24 further comprising:
displaying a result of searching for another nearby electronic device by a Bluetooth communication method;
wherein the receiving comprises, in response to the first cooking apparatus being selected from the displayed search result, receiving cooking data from the first cooking apparatus.

26. The method of claim 24, wherein:
the UI screen includes a result of searching for another nearby electronic device by a Bluetooth communication method, and
the transmitting comprises, in response to a second cooking apparatus being selected from the UI screen, transmitting cooking data to the second cooking apparatus by a Bluetooth communication method.

27. The method of claim 24, wherein the transmitting comprises transmitting cooking data by at least one of: an email, an instant message or an MMS according to a user manipulation through the UI screen.

28. The method of claim 24 further comprising:
in response to a recipe application stored in the electronic device being executed, displaying a first UI element for receiving cooking data from a cooking apparatus, a second UI element for transmitting cooking data to a cooking apparatus and a third UI element for sharing cooking data with another electronic device; and
in response to the first UI element being selected, displaying at least one of cooking apparatuses to be connected to the electronic device,
wherein the receiving comprises, in response to the first cooking apparatus being selected from among at least one of the displayed cooking apparatuses, receiving cooking data from the first cooking apparatus.

29. The method of claim 28 further comprising:
in response to the second UI element or the third UI element being selected, displaying information on at least one piece of pre-stored cooking data.
